(19) United States
(12) Patent Application Publication
(10) Pub. No.: US 2023/0245001 A1
(43) Pub. Date: Aug. 3, 2023

(54) SYSTEMS AND METHODS FOR DESTINATION OBJECT CONSOLIDATION

(71) Applicant: The Eighth Notch Inc., Alamo, CA (US)

(72) Inventor: Jamison Sapp, Alamo, CA (US)

(21) Appl. No.: 18/297,964

(22) Filed: Apr. 10, 2023

Related U.S. Application Data
(63) Continuation-in-part of application No. 17/348,302, filed on Jun. 15, 2021, now abandoned.
(60) Provisional application No. 63/040,151, filed on Jun. 17, 2020.

(51) Int. Cl. G06N 20/00

(52) U.S. Cl. CPC G06N 20/00

(57) ABSTRACT

Disclosed embodiments provide a framework to synchronize distribution of objects from one or more object distribution systems at a processor to enable consolidation of the objects for distribution to a user. In response to obtaining an object request and object distribution requests for a set of nodes, an object distribution optimization system determines an object distribution time for each node that allows for arrival of the objects at an endpoint at a time that allows the processor to consolidate these objects into a single distribution for a user. The object distribution system can finalize the object distribution requests using these object distribution times and provide these requests to the nodes to fulfill the object request and enable the processor to consolidate the objects into a single distribution for the user.

### CROSS-REFERENCE TO RELATED APPLICATIONS

The present patent application is a continuation-in-part U.S. patent application Ser. No. 17/348,302 filed Jun. 15, 2021, which claims the priority benefit of U.S. Provisional Patent Application 63/040,151 filed Jun. 17, 2020, the disclosures of which are incorporated by reference herein.

### FIELD

The present disclosure relates generally to systems and methods for consolidating objects at a destination to optimize distribution of these objects. In one example, the systems and methods described herein may be used to identify and engineer object distribution times to ensure objects are consolidated and to synchronize distribution of these objects among different distribution systems.

### SUMMARY

Disclosed embodiments may provide a framework to engineer object distribution times for recipient requests to ensure that objects destined to the recipient are distributed synchronously. The object distribution times for objects from different distribution system nodes are synchronized such that the objects arrive at an object distribution processor for distribution to the recipient in a single distribution action. Further, objects destined for a particular recipient are synchronized across various distribution systems based on object distribution information provided by an object distribution processor. Options for optimized object distribution times may be provided to the recipient to allow the recipient to have all distribution actions across multiple distribution systems consolidated into a single distribution action from an object distribution processor.

According to some embodiments, a computer-implemented method is provided. The method comprises receiving an object request. The object request corresponds to a set of objects associated with an object distribution system and a destination for distribution of the set of objects. The computer-implemented method further comprises generating in real-time a dataset. The dataset includes sample object requests and sample object distribution times corresponding to different nodes associated with a set of object distribution systems. Further, the sample object distribution times facilitate consolidation of objects associated with the sample objects requests into singular object distributions. The computer-implemented method further comprises dynamically training in real-time a machine learning algorithm to automatically generate a set of object distribution times corresponding to a set of nodes associated with the object distribution system. The computer-implemented method further comprises obtaining transit data associated with an object distribution processor. The transit data indicates transit times from the set of nodes to an endpoint corresponding to the object distribution processor and the destination. The computer-implemented method further comprises processing the object request, the transit data, and data corresponding to the set of nodes through the machine learning algorithm to identify a set of times for transiting the set of objects from the set of nodes to the endpoint. The computer-implemented method further comprises generating a set of object distribution requests. The set of object distribution requests include the object request and the set of times. Further, when the object distribution requests are received, the set of nodes transit the set of objects to the endpoint according to the set of times to allow for consolidation of the set of objects at the endpoint for consolidated distribution.

According to some embodiments, a computer-program product is provided. The computer-program product is tangibly embodied in a non-transitory machine-readable storage medium, including instructions that, when executed by one or more processors, cause the one or more processors to perform the steps of the above method.

According to some embodiments, a system is provided. The system comprises one or more processors, and one or more non-transitory machine-readable storage media containing instructions that, when executed on the one or more processors, cause the one or more processors to perform operations including the steps of the above method.

This summary is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 shows an illustrative example of an environment in which an object distribution optimization system generates a set of node distribution times for distribution requests to a set of distribution system nodes based at least in part on transit data from an object distribution processor in accordance with at least one embodiment;

FIG. 2 shows an illustrative example of an environment in which an object distribution optimization system synchronizes object distribution requests associated with a recipient across a set of object distribution systems to allow consolidated distribution of recipient objects from an object distribution processor in accordance with at least one embodiment;

FIG. 3 shows an illustrative example of an environment in which an object distribution optimization system implements a set of machine learning algorithms to dynamically and in real-time process object distribution requests to provide recipients with tailored distribution options and to consolidate object distributions performable by an object distribution processor in accordance with at least one embodiment;

FIG. 4 shows an illustrative example of an environment in which a distribution consolidation algorithm is dynamically trained to calculate different node distribution times for object distributions to an object distribution processor in response to a received object distribution request in accordance with at least one embodiment;

FIG. 5 shows an illustrative example of an environment in which a distribution consolidation algorithm is dynamically trained to calculate different node distribution times for object distributions to an object distribution processor based on any identified merge opportunities for distributions according to destination proximity in accordance with at least one embodiment;

FIG. 6 shows an illustrative example of an environment in which a distribution preference algorithm is dynamically trained to provide tailored object distribution options for a pending object distribution request based on prior object distributions in accordance with at least one embodiment;

FIG. 7 shows an illustrative example of an environment in which a logistics optimization system is implemented using a multi-tenant infrastructure to allow multiple object distribution systems to utilize the logistics optimization system concurrently in accordance with at least one embodiment;

FIG. 8 shows an illustrative example of an environment in which an object distribution system provides, through a graphical user interface (GUI), a set of expanded options to a recipient for consolidating object distributions on a particular distribution time in accordance with at least one embodiment;

FIG. 9 shows an illustrative example of an environment in which an object distribution system provides, through a GUI, a set of specific time selection options to a recipient for consolidating object distributions on a specific distribution time in accordance with at least one embodiment;

FIG. 10 shows an illustrative example of an environment in which an object distribution system provides, through a GUI, a set of personalized recipient options for consolidated object distributions based at least in part on prior object distributions in accordance with at least one embodiment;

FIG. 11 shows an illustrative example of a process for determining object distribution times for distribution system nodes of an object distribution system based on transit data from the distribution system nodes to an object distribution processor in accordance with at least one embodiment;

FIG. 12 shows an illustrative example of a process for determining object distribution times for distribution system nodes of an object distribution system based on transit data of the distribution system nodes and pending object distributions from other object distribution systems in accordance with at least one embodiment; and

FIG. 13 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to synchronize distribution of objects from one or more object distribution systems or other systems at an object distribution processor to enable consolidation of these objects for distribution to a recipient. For example, in response to obtaining an object request from a recipient, an object distribution system may identify one or more distribution system nodes (e.g., point-of-sale locations, vendor owned locations, etc.) that may fulfill the recipient request and generate initial object distribution requests for these distribution system nodes. The object distribution system may provide the object request and the proposed object distribution request to an object distribution optimization system, which may determine, for each distribution system node, an object distribution time that allows for arrival of the object at an object distribution processor along with other objects from other distribution system nodes at a time that allows the object distribution processor to consolidate these objects into a single distribution for a recipient. To identify these object distribution times, the object distribution optimization system utilizes a set of parameters corresponding to operation of each distribution system node in order to execute the object distribution and may obtain transit data associated with the object distribution processor. This transit data may be used to identify the object distribution processor transit time for object distributions from each distribution system node to the destination indicated by the recipient for distribution of their requested objects. Based on these defined parameters and transit data, the object distribution optimization system may calculate the object distribution times for each distribution system node and provide these object distribution times to the object distribution system. The object distribution system may finalize the object distribution requests using these object distribution times and provide these object distribution requests to the distribution system nodes to fulfill the object request from the recipient.

Object distribution systems define the object distribution time or time range for objects requested by the recipient. These objects may be maintained by the object distribution system or other system in different distribution system nodes located in different regions. This can result in different objects that are to be distributed to the recipient to be distributed in multiple distributions, as these different objects may arrive at an object distribution processor at different times from the different distribution system nodes. Further, object distribution systems and other systems often do not have visibility with regard to other distributions that may be scheduled for the same recipient from other object distribution systems, which may result in multiple distributions being made to the recipient. This creates significant inefficiencies for these object distribution systems, as well as for the object distribution processor, as object requests may be fulfilled using multiple distributions as opposed to a singular distribution. These multiple distributions may further have a negative impact on the environment, as multiple distributions may require additional resources, resulting in an increase in emissions (e.g., greenhouse gases, pollution, etc.). Thus, by optimizing and consolidating distributions for different recipients may result in a reduction in resources requires to fulfill object requests submitted by recipients, which in turn may have a favorable impact on the environment.

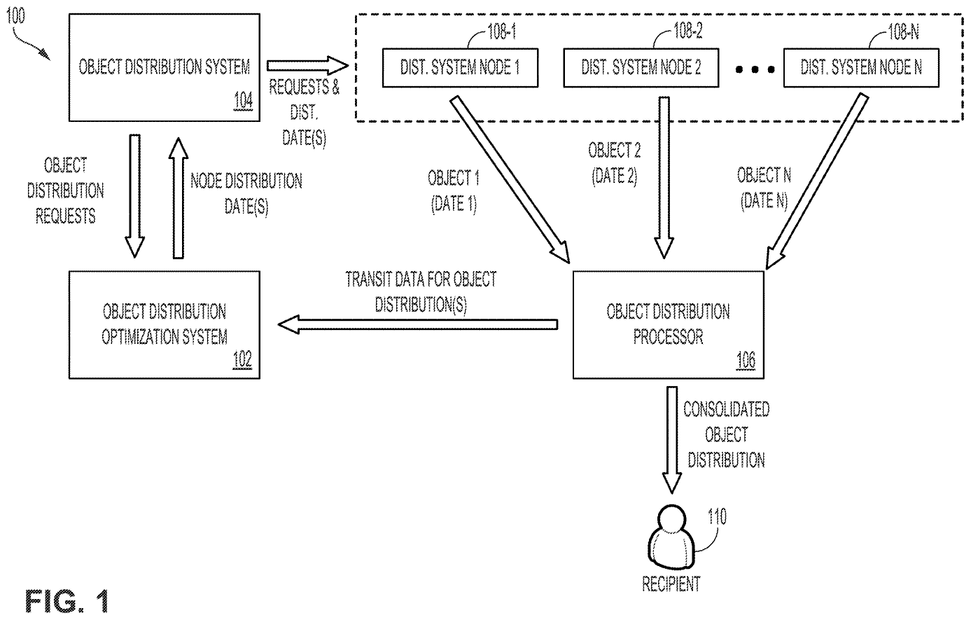

FIG. 1 shows an illustrative example of an environment 100 in which an object distribution optimization system 102 generates a set of object distribution times for object requests to a set of distribution system nodes 108-1-108-N based at least in part on transit data associated with an object distribution processor 106 in accordance with at least one embodiment. In the environment 100, an object distribution system 104 transmits a request to an object distribution optimization system 102 to identify one or more object distribution times for a set of distribution system nodes 108-1-108-N for fulfillment of an object request associated with a recipient 110. The object request may specify a target distribution time for distribution of the one or more requested objects or a window of times within which a guarantee or promise is made to the recipient 110 for distribution of these one or more requested objects. The object distribution optimization system 102 may be implemented using one or more computer systems that are configured to engineer and orchestrate distribution times for various distribution system nodes to allow for consolidation of objects from these distribution system nodes at an object distribution processor 106. The consolidation of objects (whether from a single object request or multiple object requests) at the object distribution processor 106 may provide certain benefits. For instance, rather than having to conduct multiple distributions for a recipient 110 at a particular destination for objects from one or more object requests, the different objects may be consolidated at the object distribution processor 106 and allow for distribution of these objects to the recipient 110 in a single distribution.

In an embodiment, to access the object distribution optimization system 102, the object distribution system 104 calls a representational state transfer (REST) application programming interface (API) of the object distribution optimization system 102. In this REST API call, the object distribution system 104 may provide a set of credentials that may be used to authenticate the object distribution system 104. For example, in the REST API call, the object distribution system 104 may provide its username and corresponding password to the object distribution optimization system 102. The object distribution optimization system 102 may evaluate the provided credentials to determine whether the credentials are valid. If so, the object distribution optimization system 102 may provide the object distribution system 104 with an access token that may be used by the object distribution system 104 to access the object distribution optimization system 102 without providing its credentials for a period of time (e.g., until the access token expires).

In response to obtaining an object request from a recipient 110, the object distribution system 104 may identify the one or more distribution system nodes 108-1-108-N that may be used to fulfill the object request. The distribution system nodes 108-1-108-N associated with the object distribution system 104 may be implemented in different locations. For instance, each distribution system node 108-1-108-N may be assigned to maintain and distribute certain objects or classes of objects on behalf of the object distribution system 104. Alternatively, a distribution system node 108-1-108-N may maintain certain objects or classes of objects that are subject to greater demand within a particular region associated with the distribution system node 108-1-108-N. Distribution system nodes 108-1-108-N may further be implemented near object distribution processor hubs, through which objects are transited to local object distribution processor nodes for distribution to recipients. Distribution system nodes 108-1-108-N may also be implemented at or near systems that generate or otherwise provision objects that are made available by the object distribution system 104 and distributed to its recipients. Thus, a set of objects requested by a recipient 110 may be maintained in different distribution system nodes and in different regions.

The object distribution system 104 may generate one or more object distribution requests that are to be transmitted to the identified distribution system nodes 108-1-108-N for fulfillment of the object request submitted by the recipient 110. An object distribution request may indicate which objects are to be included in an object distribution to the object distribution processor 106 for distribution to the recipient 110. In its request to the object distribution optimization system 102 to identify the object distribution times for each of the identified distribution system nodes 108-1-108-N, the object distribution system 104 may include the object distribution requests for the distribution system nodes 108-1-108-N and the object request submitted by the recipient 110. Further, in an embodiment, the object distribution system 104 provides performance metrics for each of the distribution system nodes 108-1-108-N. The performance metrics may indicate the efficiency of each of the distribution system nodes 108-1-108-N in processing and generating an object distribution for transmission to an object distribution processor 106. For instance, the performance metrics may specify a rate in which a distribution system node is able to transmit objects associated with different object distribution requests to the object distribution processor 106 on time. Further, the performance metrics may specify an average delay time for each distribution system node in generating an object distribution for transmission to the object distribution processor 106. These performance metrics may, thus, be used to identify possible object distribution times from the distribution system nodes 108-1-108-N to the object distribution processor 106.

In an embodiment, an object distribution system 104 provides, to the object distribution optimization system 102, a set of parameters corresponding to operation of the distribution system nodes 108-1-108-N and of the object distribution system 104 itself that can be used by the object distribution optimization system 102 to identify the object distribution time for each of the distribution system nodes 108-1-108-N that would allow for consolidation of the objects from these distribution system nodes 108-1-108-N at the object distribution processor 106 for distribution of these objects associated with the object request to the recipient 110. For example, the set of parameters may specify a maximum number of object distribution requests that can be processed by a distribution system node per day. As another example, the set of parameters may specify a timeframe within each day during which object distributions may be generated and transmitted from each distribution system node associated with the object distribution system 104.

The object distribution optimization system 102, in response to the request from the object distribution system 104, may automatically and in real-time evaluate the set of parameters defined by the object distribution system 104, as well as transit data from the object distribution processor 106, and a set of performance metrics for each distribution system node, to determine whether consolidation of objects corresponding to the object request associated with the recipient 110 can be performed on a target time specified in the object request. For instance, if the object distribution optimization system 102 identifies a potential time for transmission of an object from a distribution system node to an object distribution processor 106 distribution center or other hub, the object distribution optimization system 102 may determine, based on the set of parameters defined by the object distribution system 104, whether the distribution system node may initiate the transmission of the object on the potential time. For example, if the distribution system node has reached its quota for object distributions per day and/or the object distribution to the object distribution processor 106 would commence outside of the pre-defined object distribution timeframe specified in the set of parameters, the object distribution optimization system 102 may determine that object distribution from the distribution system node may not be performed on the potential object distribution time. This may result in the object distribution optimization system 102 determining whether consolidation of objects from the myriad distribution system nodes may still be performed subject to the target time specified in the object request associated with the recipient 110.

In response to the request from the object distribution system 104, the object distribution optimization system 102 may review transit data associated with the object distribution processor 106 to identify the estimated transit time from each of the distribution system nodes 108-1-108-N to the destination specified by the recipient 110 where fulfillment of the object request associated with the recipient 110 is to be made. This transit data may specify the object distribution processor transit times from different origin points to different destination points. Alternatively, the object distribution optimization system 102 may utilize the transit data to identify the estimated transit time from each of the distribution system nodes 108-1-108-N to a distribution center or hub associated with the object distribution processor 106 wherein the objects from the distribution system nodes 108-1-108-N are to be consolidated for distribution to the recipient 110.

The transit data may indicate the average transit time from an origin location within a particular region to another location (e.g., a recipient 110 destination, etc.) within another region. Using this transit data and a defined set of parameters from the object distribution system 104 for execution of the object distribution, as well as the destination defined by the recipient 110 in their object request, the object distribution optimization system 102 may calculate the transit time from each of the distribution system nodes 108-1-108-N specified in the object distribution requests provided by the object distribution system 104 to the local object distribution processor location or distribution center that will be tasked with distribution of the objects specified in the object request to the recipient 110 at the specified destination.

In an embodiment, based on these identified transit times, the defined set of parameters from the object distribution system 104, the performance metrics provided by the object distribution system 104 for each of the distribution system nodes 108-1-108-N, and/or an object distribution processor-provided object distribution time of other object distribution systems that may have objects for distribution to the recipient's specified destination, the object distribution optimization system 102 may determine the object distribution time for each of the distribution system nodes 108-1-108-N that would allow for consolidation of the objects from these distribution system nodes 108-1-108-N at the object distribution processor 106 for distribution of the objects associated with the object request to the recipient 110 in a single distribution.

In an embodiment, the object distribution optimization system 102 implements a machine learning algorithm or artificial intelligence that is dynamically trained, in real-time, to identify the object distribution times for each of the distribution system nodes 108-1-108-N. As input, the machine learning algorithm or artificial intelligence may utilize the transit times identified by the object distribution optimization system 102, the performance metrics supplied by the object distribution system 104, any prior order data for the recipient destination (e.g., past object requests, previously selected times and object distribution options, etc.), and performance metrics corresponding to fulfillment of previous object requests of the recipient 110 (e.g., accuracy in distributing objects associated with previous object requests within promised object distribution times, etc.). The output generated by the machine learning algorithm or artificial intelligence may include the object distribution times for the distribution system nodes 108-1-108-N.

The machine learning algorithm or artificial intelligence implemented by the object distribution optimization system 102 may be dynamically trained in real-time using supervised training techniques. For instance, a dataset of input object requests (e.g., prior object requests associated with different recipients, hypothetical object requests generated for training of the machine learning algorithm or artificial intelligence, etc.) and known object distribution times for different distribution system nodes associated with the input object requests (e.g., prior object distribution times for actual distribution system nodes associated with prior object requests, hypothetical object distribution times for different distribution system nodes associated with hypothetical object requests, etc.) can be selected for training of the machine learning algorithm or artificial intelligence. Additionally, the dataset may include any applicable parameters and/or performance characteristics associated with the different distribution system nodes that may be used for object distributions. These parameters and/or performance characteristics, along with the known object distribution times, may be used to define a ground truth for dynamic evaluation of the machine learning algorithm or artificial intelligence to ensure that the machine learning algorithm or artificial intelligence is generating accurate object distribution times for any identified distribution system nodes associated with different object distribution requests.

The machine learning algorithm or artificial intelligence implemented by the object distribution optimization system 102 may be evaluated in real-time to determine, based on the sample input object requests supplied to the machine learning algorithm or artificial intelligence, whether the machine learning algorithm or artificial intelligence is accurately identifying the appropriate object distribution times for the different distribution system nodes associated with these sample input object requests. Based on this evaluation, the machine learning algorithm or artificial intelligence may be re-trained or otherwise updated in real-time to increase the likelihood of the machine learning algorithm or artificial intelligence generating the desired results. The machine learning algorithm or artificial intelligence may further be dynamically updated by soliciting feedback from object distribution systems, such as the object distribution system 104, with regard to any provided object distribution times for the one or more distribution system nodes 108-1-108-N used to transit objects associated with different object requests to the object distribution processor 106. For instance, the object distribution system 104 may evaluate any provided object distribution times for the one or more distribution system nodes 108-1-108-N to determine whether these object distribution times comport with one or more existing parameters associated with the one or more distribution system nodes 108-1-108-N. As another illustrative example, the object distribution system 104 may provide feedback corresponding to any provided object distribution times to determine whether the object distributions from the one or more distribution system nodes 108-1-108-N were performed according to these provided object distribution times.

In an embodiment, feedback usable to dynamically re-train or otherwise update the machine learning algorithm or artificial intelligence implemented by the object distribution optimization system 102 can include data from the object distribution processor 106 corresponding to actual consolidation of objects associated with different object requests corresponding to different recipients. For example, if a set of objects were transmitted from one or more distribution system nodes 108-1-108-N to the object distribution processor 106 on specified object distribution times, but the objects could not be consolidated for distribution to a corresponding recipient 110, the object distribution processor 106 may provide feedback or other data indicating the cause for this failure to consolidate these objects into a single distribution. This feedback or other data may be used to dynamically re-train or otherwise update the machine learning algorithm or other artificial intelligence such that, for similar object requests and/or recipients, the machine learning algorithm or artificial intelligence may identify more accurate object distribution times for the one or more distribution system nodes 108-1-108-N.

It should be noted that the machine learning algorithm or artificial intelligence implemented to dynamically, and in real-time, provide the object distribution times for different distribution system nodes 108-1-108-N that are to transmit objects to the object distribution processor 106 for consolidation into a single distribution is dynamically trained, in real-time, as different requests associated with different object distribution systems are submitted to the object distribution optimization system 102 for generation of object distribution times for the myriad distribution system nodes associated with these different object distribution systems. For example, the machine learning algorithm or artificial intelligence implemented by the object distribution optimization system 102 may simultaneously, and continuously, process different requests from different object distribution systems (such as object distribution system 104) and corresponding to different object requests submitted by myriad recipients (such as recipient 110) to provide object distribution times for the distribution system nodes associated with these different object distribution systems. Further, as these object distribution times are provided to these different object distribution systems and as objects associated with different object requests are distributed, any feedback received corresponding to these provided object distribution times may be used to dynamically, and in real-time, re-train or otherwise update the machine learning algorithm or artificial intelligence. Thus, as object distribution times are provided to different object distribution systems and as distributions are made by the object distribution processor 106 to different recipients for different object requests, the machine learning algorithm or artificial intelligence, in real-time, may continuously generate object distribution times for new requests from the different object distribution systems and may be continuously re-trained or otherwise updated as feedback is received corresponding to these object distribution times.

The object distribution optimization system 102 may provide the identified object distribution times for the distribution system nodes 108-1-108-N to the object distribution system 104 to fulfill the request from the object distribution system 104. This may cause the object distribution system 104 to finalize the object distribution requests for the distribution system nodes 108-1-108-N. For instance, each object distribution request may indicate the object distribution time for the corresponding distribution system node to initiate transit of one or more objects from the distribution system node to the object distribution processor 106 for consolidation with other objects from other distribution system nodes. In an embodiment, the object distribution system 104 transmits the object distribution requests to the distribution system nodes 108-1-108-N concurrently such that the distribution system nodes 108-1-108-N may obtain their respective object distribution requests at the same time. Alternatively, the object distribution system 104 may stagger transmission of the object distribution requests to the distribution system nodes 108-1-108-N according to the object distribution times generated by the object distribution optimization system 102.

In an embodiment, the object distribution optimization system 102 automatically, and in real-time, generates a set of analytics or other data that can be used to identify potential optimizations to the operation of the object distribution system 104 in distributing objects to recipients, such as recipient 110. For instance, if the object distribution optimization system 102 determines that a target object distribution time specified by the recipient 110 cannot be met as a result of one or more parameters defined by the object distribution system 104, the object distribution optimization system 102 may utilize a machine learning model, dynamically trained in real-time by the object distribution optimization system 102, to simulate alternative scenarios whereby different parameters are defined that allow for object distribution to the recipient 110 on or prior to the target object distribution time. For instance, if a parameter defined by the object distribution system 104 indicates that each distribution system node 108-1-108-N is subject to an object distribution limit, whereby no additional object distributions may be made from a distribution system node once the limit is reached, the object distribution optimization system 102 may dynamically adjust this object distribution limit to determine whether additional opportunities for consolidation of objects become apparent and/or to determine whether the target object distribution time may be met as a result of a change to the limit. As another example, if a set of parameters from the object distribution system 104 indicates that the object distribution optimization system 102 is to continue querying for pending object distributions that may be used for consolidation with a pending object distribution from the object distribution system 104 to the recipient 110 for a period of time, the object distribution optimization system 102 may simulate this querying beyond the pre-defined period of time to determine whether additional object distribution consolidation opportunities become available.

The object distribution optimization system 102, based on the set of simulations performed using a modified set of parameters (wherein the modified set of parameters are generated by changing one or more parameters of the parameters defined by the object distribution system 104), may dynamically generate one or more optimizations for the object distribution system 104 to optimize the object distribution time offerings that may be provided to recipients. For instance, the object distribution optimization system 102 may identify optimizations to the operation of the object distribution system 104 based on individual changes to parameters of the set of parameters provided by the object distribution system 104. As an example, if the object distribution system 104 were to modify a parameter to change the time limit for obtaining recipient object requests that can then be provided to a distribution system node on the same day as the recipient object requests, the object distribution optimization system 102 may qualify and quantify the benefit to the object distribution system 104 through presentation of resource savings (e.g., via consolidation of objects for recipients) and other benefits (object delivery processor incentives for increased consolidation of objects, etc.). The object distribution optimization system 102 may provide these analytics to the object distribution system 104, which may allow the object distribution system 104 to apply changes to its set of parameters based on the analytics provided by the object distribution optimization system 102.

In an embodiment, the machine learning algorithm or artificial intelligence implemented by the object distribution optimization system 102 to provide object distribution systems with different object distribution optimizations is dynamically trained in real-time using supervised training techniques. For instance, a dataset of input recipient object requests (e.g., prior object requests including specified target object distribution times, hypothetical object requests including hypothetical target object distribution times, etc.), object distribution system parameters (e.g., actual parameters, hypothetical parameters, etc.), and known outcomes (e.g., prior and/or hypothetical optimizations, prior and/or hypothetical performance data resulting from adherence to the optimizations, etc.) can be selected for training of the machine learning algorithm or artificial intelligence. The machine learning algorithm or artificial intelligence may be evaluated in real-time to determine, based on the sample input object requests and associated parameters, whether the machine learning algorithm or artificial intelligence is accurately identifying appropriate object distribution optimizations (e.g., changes to the associated parameters, incentivizing alternative target object distribution times according to identified object consolidation opportunities, etc.) that may be implemented to provide greater opportunities for object consolidation at an object distribution processor to minimize the number of distributions required.

In an embodiment, the machine learning algorithm or artificial intelligence can be further dynamically re-trained or otherwise updated based on feedback regarding any provided optimizations. For example, the object distribution optimization system 102 may monitor, in real-time, adherence to any provided optimizations to determine whether the adherence to these provided optimizations has had the desired effect (e.g., improving performance of distribution system nodes in transmitting objects that are subsequently consolidated to minimize the number of object distributions, the actual number of object distributions made has been reduced by a predicted amount, etc.). As an illustrative example, if an object distribution system 104 adheres to a provided optimization and the resulting number of distributions made to recipients associated with the object distribution system 104 has not been reduced by a predicted or threshold amount, the object distribution optimization system 102 may determine that the provided optimization did not have the desired effect. Accordingly, the object distribution optimization system 102 may use this feedback (e.g., data corresponding to the optimization and the resulting effect) to re-train the machine learning algorithm or artificial intelligence such that, for similar object distribution systems and/or object requests, the machine learning algorithm or artificial intelligence may be less likely to provide a similar optimization. Alternatively, if the object distribution optimization system 102 determines that a provided optimization has had the desired or predicted effect (e.g., a predicted reduction in the number of distributions made for object requests, improvement in the efficiency of distribution system nodes, etc.), the object distribution optimization system 102 may dynamically update the machine learning algorithm or artificial intelligence in real-time to reinforce the machine learning algorithm or artificial intelligence such that, for similar object distribution systems and/or object requests, the machine learning algorithm or artificial intelligence may be likely to provide similar optimizations.

In some instances, the feedback usable to dynamically re-train or otherwise update the machine learning algorithm or artificial intelligence can further include data from the object distribution system 104 itself. For example, an object distribution system 104 may evaluate a provided optimization to determine whether the actions indicated in the provided optimization may be performed. As an illustrative example, if a provided optimization indicates that greater object distribution consolidations may be achieved if the defined limit of distributions that may be performed by distribution system nodes is increased by a particular amount, and the object distribution system 104 determines that such an increase cannot be performed (e.g., violates one or more other parameters, is physically not possible, would require significant resources, etc.), the object distribution system 104 may provide feedback indicating that such an optimization cannot be adhered to based on the actual limitations associated with its distribution system nodes. Accordingly, the object distribution optimization system 102 may use this feedback to dynamically update the machine learning algorithm or artificial intelligence such that, for the object distribution system 104 and similar object distribution systems, the likelihood of similar optimizations being generated is reduced.

It should be noted that the machine learning algorithm or artificial intelligence implemented to dynamically, and in real-time, generate optimizations to different object distribution systems (such as object distribution system 104) is dynamically trained, in real-time, as different object requests are processed by these different object distribution systems and as object distributions are consolidated and performed for different object requests. For example, the machine learning algorithm or artificial intelligence implemented by the object distribution optimization system 102 may simultaneously, and continuously, process incoming object requests associated with different recipients and corresponding object distribution systems, as well as any available performance data corresponding to these object distribution systems (e.g., performance metrics associated with distribution system nodes associated with these object distribution systems, prior data corresponding to object distribution consolidations performed by the object distribution processor 106, etc.), to dynamically and in real-time provide these different object distribution systems with tailored optimizations for reducing the number of object distributions required for fulfillment of myriad object requests for different recipients. Further, as these optimizations are provided to these different object distribution systems, any feedback received corresponding to these optimizations may be used to dynamically, and in real-time, re-train or otherwise update the machine learning algorithm or artificial intelligence. Thus, as optimizations are provided to different object distribution systems and as object distributions are made by the object distribution processor 106 to different recipients for different object requests, the machine learning algorithm or artificial intelligence may continuously and in real-time generate optimizations for different object distribution systems and for different object requests.

In an embodiment, the object distribution optimization system 102 can process requests to identify a target retrieval time for objects from a recipient 110 to the object distribution system 104 based on any pending object distributions to be made to the recipient 110. For instance, a recipient 110 may submit a request to an object distribution system 104 to return one or more objects to the object distribution system 104 in order to obtain restitution from the object distribution system 104, exchange the one or more objects for other objects, or for any other purpose. In response to the request from the recipient 110, the object distribution system 104 may submit a request to the object distribution optimization system 102 to determine whether any object distributions are to be made at the recipient's location.

The request to the object distributions optimization system 102 may include a set of parameters defined by the object distributions system 104 that may be used to determine whether one or more objects may be obtained from a recipient 110 by the object distribution processor 106 concurrently with an object distribution that is to be made to the recipient 110 by the object distribution processor 106. The set of parameters may specify a time limitation from the time of receipt of the recipient's request for obtaining the one or more objects from the recipient 110. For example, the object distributions system 104 may indicate, via the set of parameters, that the one or more objects from the recipient 110 are to be obtained within a certain number of days from the time in which the recipient 110 submitted their request to return the one or more objects to the object distributions system 104.

In response to the request from the object distributions system 104, the object distributions optimization system 102 may determine whether there are any scheduled object distributions that are to be made by the object distribution processor 106 to the recipient 110 at a destination specified by the recipient 110. For instance, the object distribution optimization system 102 may query the object distribution processor 106 to identify any scheduled object distributions that are to be made to the recipient 110 at the destination specified by the recipient 110. Alternatively, the object distribution optimization system 102 may query an object distribution orchestration system maintained by the object distribution optimization system 102 to identify any pending object distribution times for object distributions that are to be made to the recipient 110 from the object distribution system 104 or any other object distribution system associated with the object distribution optimization system 102. If the object distribution optimization system 102 determines that no object distributions are scheduled to be made to the recipient 110, the object distribution optimization system 102 may evaluate the set of parameters provided by the object distribution system 104 to identify a retrieval time at which the object distribution processor 106 is to obtain the one or more objects from the recipient 110 and initial object distribution of the one or more objects to the object distribution system 104 (e.g., at a distribution system node associated with the object distribution system 104, other destination designated by the object distribution system 104 for distribution of returned objects, etc.). In an embodiment, the object distribution optimization system 102 transmits a request to the object distribution processor 106 to identify, in accordance with the set of parameters provided by the object distribution system 104, a time at which the object distribution processor 106 may retrieve the one or more objects from the recipient 110. For instance, the object distribution processor 106 may identify a time in which an object distribution is scheduled to be made within the vicinity of the recipient's specified destination. The object distribution processor 106 may provide this information to the object distribution optimization system 102, which may use this information to select a retrieval time for the one or more objects from the recipient 110.

In an embodiment, if the object distribution optimization system 102 identifies one or more object distribution times for objects from the object distribution system 104 and/or other object distribution systems to the recipient 110 at the destination specified by the recipient 110 in their request to the object distribution system 104, the object distribution optimization system 102 determines whether any of the one or more object distribution times satisfy the set of parameters provided by the object distribution system 104 for retrieval of the one or more objects that are to be returned to the object distribution system 104. For instance, if the set of parameters specify a final time for return of one or more objects from the recipient 110 to the object distribution system 104, the object distribution optimization system 102 may determine whether the one or more object distribution times corresponding to object distributions that are to be made to the recipient 110 are prior to this final time and, if so, whether object distribution of the one or more objects from the recipient 110 to the object distribution system 104 may be completed prior to or on the final time as identified based on the set of parameters.

If the object distribution optimization system 102 identifies an object distribution time that satisfies the set of parameters provided by the object distribution system 104 to allow for retrieval of one or more objects from the recipient 110 to the object distribution system 104, the object distribution optimization system 102 may provide a response to the object distribution system 104 that includes this time. This may allow the object distribution system 104 to indicate, to the recipient 110, that the one or more objects from the recipient 110 may be retrieved by the object distribution processor 106 on the specified time for distribution to the object distribution system 104. If the recipient 110 confirms that this specified time is acceptable, the object distribution system 104 may transmit a confirmation to the object distribution optimization system 102 for retrieval of the one or more objects from the recipient 110. In response to this confirmation, the object distribution optimization system 102 may transmit a notification to the object distribution processor 106 to indicate that one or more objects from the recipient 110 are to be retrieved on the specified time and during object distribution of other objects to the recipient 110 from the object distribution system 104 and/or other object distribution systems.

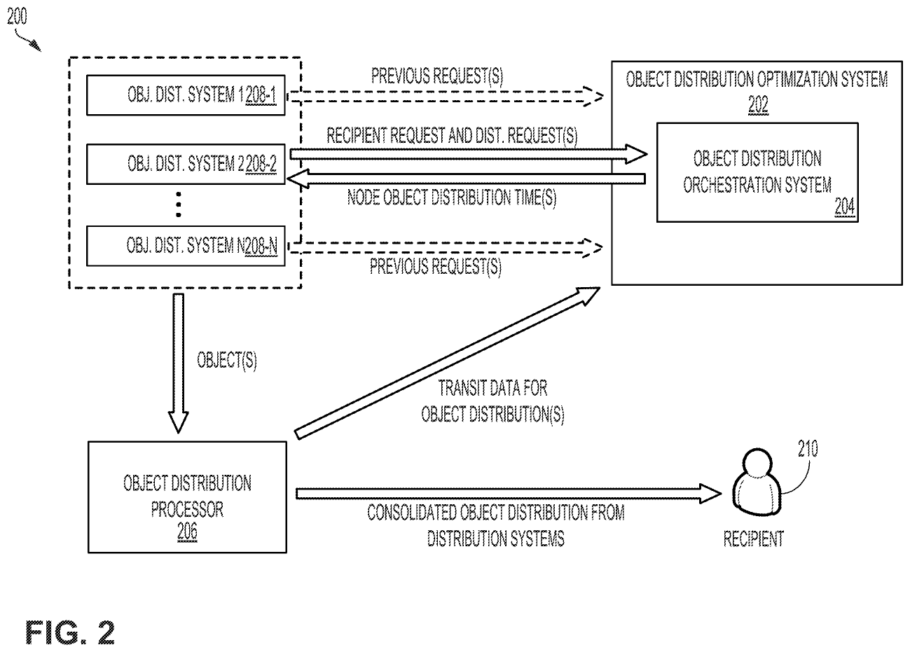

FIG. 2 shows an illustrative example of an environment 200 in which an object distribution optimization system 202 synchronizes object distribution requests associated with a recipient 210 across a set of different object distribution systems 208-1-208-N to allow for consolidated object distribution of objects from an object distribution processor 206 in accordance with at least one embodiment. In the environment 200, an object distribution system 208-2 accesses the object distribution optimization system 202 to identify an object distribution time for each of its distribution system nodes that are tasked to fulfill an object request. For instance, when a recipient submits an object request to the object distribution system 208-2, the object distribution system 208-2 may identify one or more distribution system nodes that may fulfill the request. Each distribution system node may maintain and transmit particular objects and/or classes of objects to different local object distribution process locations or distribution nodes for the object distribution to the recipient associated with the object distribution system 208-2. The distribution system nodes associated with the object distribution system 208-2 may be located in different locations or regions. Further, a distribution system node may maintain certain objects or classes of objects that are subject to greater demand within a particular region associated with the distribution system node. Distribution system nodes may further be located near object distribution processor hubs, through which objects are transited to local object distribution processor locations for distribution to the recipient 210. Distribution system nodes may also be located at or near systems that manufacture or otherwise obtain the objects made available by the object distribution system 208-2 and distributed to its recipients. Thus, a set of objects requested by a recipient 210 may be maintained in different distribution system nodes and in different regions. The object distribution system 208-2 may define one or more object distribution requests that are to be provided to the identified distribution system nodes, which may use these object distribution requests to select its assigned objects and transmit these assigned objects to the local object distribution processor location or distribution center.

The object distribution system 208-2 may provide the object request and object distribution requests for a particular recipient 210 to an object distribution orchestration system 204 of the object distribution optimization system 202. The object distribution orchestration system 204, in an embodiment, is a SaaS-based system that can be accessed by an object distribution system via authorized API calls. The object distribution orchestration system 204 may be configured to identify one or more object distribution times for each distribution system node associated with an object distribution system 208-2 based on transit data associated with an object distribution processor 206, and a defined set of parameters that each object distribution location needs; as well as any times corresponding to pending object distributions scheduled for the recipient 210.

In an embodiment, in response to obtaining the object requests and object distribution requests from the object distribution system 208-2, the object distribution orchestration system 204 obtains transit data from the object distribution processor 206. This transit data may specify the transit times for an origin and destination nodes. For instance, the transit data may indicate the transit time from a particular region associated with a distribution system node associated with the object distribution system to another region associated with the recipient. Using this transit data, as well as the destination provided by the recipient 210 in their object request, the object distribution orchestration system 204 may automatically and in real-time calculate the transit time from each of the distribution system nodes specified in the object distribution requests for the distribution of the objects specified in the object request to the recipient 210 at the specified destination.

In an embodiment, the object distribution orchestration system 204 queries, in real-time, the object distribution processor 206 to identify any pending object distributions scheduled for the recipient 210 at the destination specified in the object request provided by the object distribution system 208-2. For instance, in response to previous object requests from other object distribution systems (e.g., object distribution system 208-1 and object distribution system 208-N), the object distribution orchestration system 204 may have provided object distribution times for the distribution system nodes associated with these other object distribution systems. The object distribution processor 206 may obtain, from these other object distribution systems, information indicating the pendency of objects from these distribution system nodes. This information may include the object distribution time to the recipient 210. In an embodiment, the object distribution orchestration system 204 maintains object distribution times for objects to the recipient 210 at the specified destination for other object distribution systems. These other object distribution systems may also utilize the object distribution optimization system 202 to coordinate and synchronize distribution of their objects to recipients. However, these other object distribution systems may otherwise be unrelated to object distribution system 208-2.

Based on the pending object distribution times for objects from other object distribution systems, the transit data provided by the object distribution processor 206, and a defined set of parameters, the object distribution orchestration system 204 may automatically and in real-time determine whether there are any opportunities to consolidate these objects from other object distribution systems with the object request from object distribution system 208-2 to allow for a single object distribution to the recipient 210 at the provided destination. For instance, if the object request indicates a preferred object distribution time or time range, the object distribution orchestration system 204 may determine, based on the transit data for the distribution system nodes associated with the object distribution system 208-2, whether the objects from these distribution system nodes will arrive at the object distribution processor 206 in time to allow for consolidation with the pending object distributions from these other object distribution systems. If so, the object distribution orchestration system 204 may define an object distribution time for each distribution system node associated with the object distribution system 208-2 that is to fulfill the request to allow for the objects from these distribution system nodes to be consolidated to allow for a single distribution to the destination indicated by the recipient 210.

In an embodiment, the object distribution orchestration system 204 provides the object distribution system 208-2 with various object distribution time options that allow for consolidation of the object request with other objects from other object distribution systems (e.g., object distribution system 208-1, object distribution system 208-N). For instance, rather than providing a completed object request, the object distribution system 208-2 may provide proposed object distribution times to the recipient 210 to allow the recipient 210 to determine whether to select a proposed object distribution time to allow for consolidation of their objects associated with the object request and other object requests (whether associated with the object distribution system 208-2 and/or other object distribution systems) or to maintain the originally provided target object distribution time.

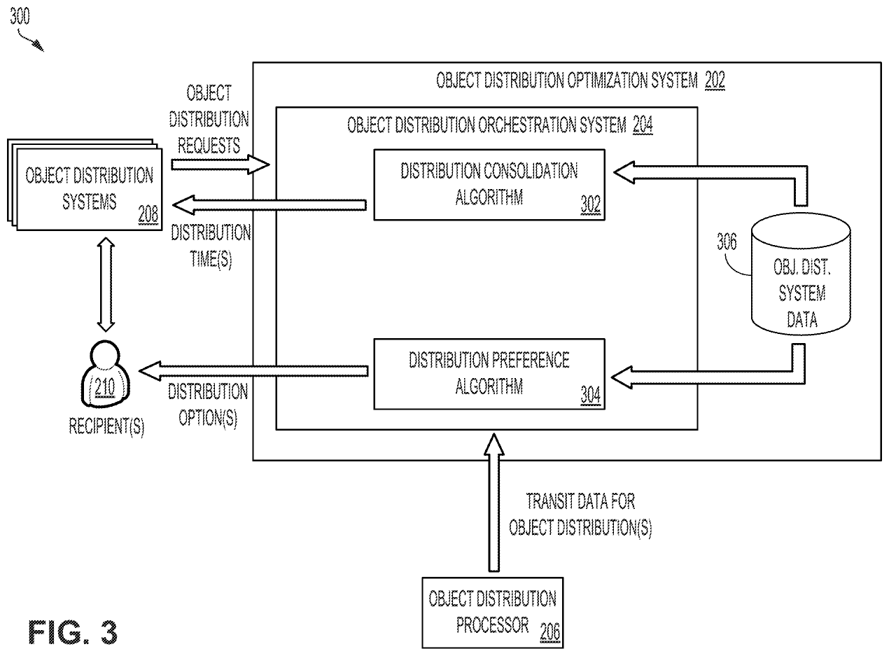

FIG. 3 shows an illustrative example of an environment 300 in which an object distribution optimization system 202 implements a set of machine learning algorithms to dynamically and in real-time process object distribution requests to provide recipients 210 with tailored distribution options and to consolidate object distributions performable by an object distribution processor 206 in accordance with at least one embodiment. In the environment 300, the object distribution optimization system 202, through the object distribution orchestration system 204, may implement a distribution consolidation algorithm 302 that is dynamically trained, in real-time, to simultaneously and continuously process incoming object distribution requests from different object distribution systems 208 to generate different object distribution times for the distribution system nodes associated with these different object distribution systems 208. For instance, in response to an object request from a recipient 210 for one or more objects that are to be distributed to the recipient 210 at a specified destination, an object distribution system 208 may transmit an object distribution request to the object distribution orchestration system 204. The object distribution request may include the object request submitted by the recipient 210, which may specify any target distribution times specified by the recipient 210 (e.g., a specific target distribution time, a target range of distribution times, etc.) and a destination for distribution of the objects associated with the object request. Additionally, the object distribution request may indicate which distribution system nodes associated with the object distribution system are to be utilized to transmit the objects associated with the object request to the object distribution processor 206 for distribution to the recipient 210 at the specified destination. In some instances, the object distribution system 208 may further provide, in its object distribution request, any applicable parameters that may denote any limitations or constraints applicable to the designated destination system nodes, as described above.

In response to the object distribution request, the object distribution orchestration system 204 may apply the object distribution request as input to the distribution consolidation algorithm 302 to dynamically generate a set of object distribution times for the designated distribution system nodes for transmission of the objects associated with the object request to the object distribution processor 206. The distribution consolidation algorithm 302 may be dynamically trained, in real-time, using supervised training techniques. For instance, a dataset of input object requests (e.g., prior object requests associated with different recipients, hypothetical object requests generated for training of the distribution consolidation algorithm 302, etc.) and known object distribution times for different distribution system nodes associated with the input object requests (e.g., prior object distribution times for actual distribution system nodes associated with prior object requests, hypothetical object distribution times for different distribution system nodes associated with hypothetical object requests, etc.) can be selected for training of the distribution consolidation algorithm 302. Additionally, the dataset may include any applicable parameters and/or performance characteristics associated with the different distribution system nodes that may be used for object distributions. These parameters and/or performance characteristics, along with the known object distribution times, may be used to define a ground truth for dynamic evaluation of the distribution consolidation algorithm 302 to ensure that the distribution consolidation algorithm 302 is generating accurate object distribution times for any identified distribution system nodes associated with different object distribution requests. This dataset may be obtained from an object distribution system datastore 306 maintained by the object distribution optimization system 202.

The object distribution system datastore 306 may include information specific to the object distribution systems 208 associated with the object distribution optimization system 202 and that may be used by the distribution consolidation algorithm 302 to dynamically in real-time identify the object distribution times for each distribution system node associated with an obtained object request. Further, as described in greater detail herein, the information included in the object distribution system datastore 306 may further be used by a distribution preference algorithm 304 to generate different object distribution time options that may be provided to recipients 210 for their object requests based on recipient preferences and prior data. For instance, the object distribution system datastore 306 may include prior data and preferences for each recipient associated with the various object distribution systems 208. This prior data may include previous object requests fulfilled by the object distribution systems 208, destinations to which object distributions were provided to recipients 210, the object distribution options selected by recipients 210 for each previous object request, and the like.

The object distribution system datastore 306 may further include performance metrics for each of the distribution system nodes associated with the various object distribution systems 208. These performance metrics may include scores corresponding to the rates in which the different distribution system nodes are able to transmit objects to the object distribution processor 206 according to designated object distribution times. Further, the performance metrics may indicate a score corresponding to the rate in which object distributions made to recipients were made according to the target object distribution times provided to these recipients 210 as opposed to other times, whether prior to or after the target object distribution times provided to the recipients 210. The performance metrics and prior data from the object distribution system datastore 306 may be used to dynamically train the distribution consolidation algorithm 302 to generate object distribution times for each distribution system node associated with a received object request to ensure that the objects from these distribution system nodes arrive at the object distribution processor 206 for consolidation and distribution to the recipient on an object distribution time indicated to the recipient by the object distribution system.

The distribution consolidation algorithm 302 may be evaluated in real-time to determine, based on the sample input object requests supplied to the distribution consolidation algorithm 302, whether the distribution consolidation algorithm 302 is accurately identifying the appropriate object distribution times for the different distribution system nodes associated with these sample input object requests. Based on this evaluation, the distribution consolidation algorithm 302 may be re-trained or otherwise updated in real-time to increase the likelihood of the distribution consolidation algorithm 302 generating the desired results. The distribution consolidation algorithm 302 may further be dynamically updated by soliciting feedback from the object distribution systems 208 with regard to any provided object distribution times for the one or more distribution system nodes used to transit objects associated with different object requests to the object distribution processor 206.

In an embodiment, feedback usable to dynamically re-train or otherwise update the distribution consolidation algorithm 302 can include data from the object distribution processor 206 corresponding to actual consolidation of objects associated with different object requests corresponding to different recipients 210. For example, if a set of objects were transmitted from one or more distribution system nodes to the object distribution processor 206 on specified object distribution times, but the objects could not be consolidated for distribution to a corresponding recipient, the object distribution processor 206 may provide feedback or other data indicating the cause for this failure to consolidate these objects into a single distribution. This feedback or other data may be used to dynamically re-train or otherwise update the distribution consolidation algorithm 302 such that, for similar object requests and/or recipients, the distribution consolidation algorithm 302 may identify more accurate object distribution times for the one or more distribution system nodes, subject to any applicable parameters as defined by the corresponding object distribution system.

In response to an object distribution request from an object distribution system, the object distribution orchestration system 204 may use this object distribution request as input to the distribution consolidation algorithm 302 to dynamically, and in real-time, generate a set of object distribution times for the distribution system nodes that are to be engaged for fulfillment of a recipient's object request. As noted above, the distribution system nodes may be identified in the object distribution request submitted by the object distribution system. The distribution consolidation algorithm 302 may use the transit data for object distributions from the object distribution processor 206, as well as any available data from the object distribution system datastore 306 corresponding to the identified distribution system nodes and to any other pending object distributions corresponding to the recipient and that may be associated with any of the object distribution systems 208 associated with the object distribution optimization system 202 to identify any opportunities for consolidating the objects corresponding to the object distribution request with other objects that are to be distributed to the destination indicated by the recipient. For instance, if the distribution consolidation algorithm 302 determines that the current object request can be merged with a pending object distribution associated with another object distribution system that is to be made to the same destination, the distribution consolidation algorithm 302 may automatically calculate a set of object distribution times for the distribution system nodes associated with the current object request to allow for consolidation of these objects along with the objects associated with the pending object distribution into a single distribution by the object distribution processor 206.

In an embodiment, if the distribution consolidation algorithm 302 determines that there are no pending object distributions that are to be made to the recipient at the indicated destination, the distribution consolidation algorithm 302 can calculate a probability of other object distributions being made to this destination within a pre-defined time window. The pre-defined time window may correspond to the target distribution time specified in the object distribution request. For example, if the object distribution request indicates a target distribution time of May 23rd and the object request was submitted on May 19th, the distribution consolidation algorithm 302 may calculate the probability of the recipient submitting a new object request between May 19th and May 23rd that would allow for consolidation of the objects associated with these object requests at the object distribution processor 206 into a single distribution that could be performed prior to or on May 23rd. This probability may be calculated based on prior object distribution data associated with the recipient and/or destination indicated in the object distribution request. For example, if a recipient frequently submits object requests to different object distribution systems 208 for which object distributions are made on Fridays, and the newly received object distribution request corresponds to an object request with a target object distribution time range that includes a Friday, the distribution consolidation algorithm 302 may determine that the probability of another object being distributed to the recipient on that Friday is particularly high. Accordingly, the distribution consolidation algorithm 302 may hold this object distribution request for a period of time according to the target object distribution time to allow for additional object requests to be received that may have target object distribution times corresponding to the upcoming Friday.

In some instances, the calculated probabilities for receiving new object requests for the indicated destination may be subject to a pre-defined threshold, whereby if the threshold is not met, the distribution consolidation algorithm 302 may proceed to calculate the object distribution times for the distribution system nodes specified in the object distribution request and subject to the target distribution time indicated by the recipient. For example, if no time leading up to the target object distribution time is associated with a probability that satisfies the pre-defined threshold, the distribution consolidation algorithm 302 may determine that it is unlikely that another object request is to be made that may be consolidated with the current object request. However, if the distribution consolidation algorithm 302 determines that another object request is likely to be received that would allow for consolidation of the current object request with this other object request subject to the specified target distribution time, the distribution consolidation algorithm 302 may hold the current object distribution request for a period of time up to the expected time at which the new object request is predicted to be received.

It should be noted that the distribution consolidation algorithm 302 implemented to dynamically, and in real-time, provide the object distribution times for different distribution system nodes that are to transmit objects to the object distribution processor 206 for consolidation into a single distribution is dynamically trained, in real-time, as different requests associated with different object distribution systems 208 are submitted to the object distribution optimization system 202 for generation of object distribution times for the myriad distribution system nodes associated with these different object distribution systems 208. For example, the distribution consolidation algorithm 302 may simultaneously, and continuously, process different requests from different object distribution systems 208 and corresponding to different object requests submitted by myriad recipients 210 to provide object distribution times for the distribution system nodes associated with these different object distribution systems 208. Further, as these object distribution times are provided to these different object distribution systems 208 and as objects associated with different object requests are distributed to the recipients 210 by the object distribution processor 206, any feedback received corresponding to these provided object distribution times may be used to dynamically, and in real-time, re-train or otherwise update the distribution consolidation algorithm 302. Thus, as object distribution times are provided to different object distribution systems 208 and as distributions are made by the object distribution processor 206 to different recipients 210 for different object requests, the distribution consolidation algorithm 302, in real-time, may continuously generate object distribution times for new requests from the different object distribution systems 208 and may be continuously re-trained or otherwise updated as feedback is received corresponding to these object distribution times.

In an embodiment, the object distribution orchestration system 204 further implements a distribution preference algorithm 304 that is dynamically trained, in real-time, to provide, through the object distribution systems 208, different object distribution options corresponding to different target object distribution times or time ranges for distribution of objects to these recipients at their indicated destinations. The distribution preference algorithm 304 may be dynamically trained in real-time using supervised training techniques. For instance, a dataset of input object requests (e.g., prior object requests associated with different recipients, hypothetical object requests generated for training of the distribution preference algorithm 304, etc.) and known object distribution preferences corresponding to object distributions (e.g., prior object distribution preferences, hypothetical object distribution preferences, etc.) can be selected for training of the distribution preference algorithm 304. As noted above, the distribution preference algorithm 304 may obtain, from the object distribution system datastore 306, prior data and preferences for each recipient associated with the various object distribution systems 208. This prior data may include previous object requests fulfilled by the object distribution systems 208, destinations to which object distributions were provided to recipients 210, the object distribution options selected by recipients 210 for each previous object request, and the like. Thus, the prior data from the object distribution system datastore 306 may be used to construct the dataset used to dynamically train, in real-time, the distribution preference algorithm 304.

The distribution preference algorithm 304 may be evaluated in real-time to determine, based on the sample input object requests supplied to the distribution preference algorithm 304, whether the distribution preference algorithm 304 is accurately identifying different object distribution options according to prior preferences associated with a recipient and the one or more parameters associated with the corresponding object distribution system. Based on this evaluation, the distribution preference algorithm 304 may be re-trained or otherwise updated in real-time to increase the likelihood of the distribution preference algorithm 304 generating the desired results. The distribution preference algorithm 304 may further be dynamically updated by obtaining feedback from recipients 210 and object distribution systems 208 with regard to any presented object distribution options corresponding to submitted object requests. For instance, if a recipient foregoes selecting any of the provided object distribution options and instead selects an alternative object distribution option not provided by the distribution preference algorithm 304, the distribution preference algorithm 304 may be dynamically updated in real-time such that, for similar recipients and/or object requests, the distribution preference algorithm 304 may be less likely to provide or otherwise prominently present these options. Further, the distribution preference algorithm 304, for similar recipients and/or object requests, may be dynamically trained to increase the likelihood of the selected distribution option being prominently presented or otherwise provided to these similar recipients and/or for the similar object requests.

The object distribution options may correspond to different target object distribution times or time ranges for distribution of the objects associated with the object request. For instance, a particular object distribution option may correspond to a target object distribution time that represents the fastest possible distribution of the requested objects to the recipient's indicated destination, subject to any parameters defined by the corresponding object distribution system and the transit data associated with the object distribution processor 206. As another illustrative example, another object distribution option may correspond to a target object distribution time that allows for consolidation of the objects associated with the object request with other objects corresponding to pending object distributions, as described above. As yet another illustrative example, an object distribution option may allow the object distribution system, through the object distribution optimization system 202 to dynamically select a target object distribution time that allows for consolidation of a maximum number of objects into a single distribution to the destination indicated by the recipient.

It should be noted that the distribution preference algorithm 304 implemented to dynamically, and in real-time, provide different object distribution options to recipients 210 in response to their object requests is dynamically trained, in real-time, as different object requests associated with different recipients 210 are obtained. For example, the distribution preference algorithm 304 may simultaneously, and continuously, process different object requests associated with different recipients 210 to provide different object distribution options to these different recipients 210. Further, as these different object distribution options are provided to these different recipients 210, any feedback (e.g., selections, etc.) received corresponding to these different object distribution options for the corresponding object requests may be used to dynamically, and in real-time, re-train or otherwise update the distribution preference algorithm 304. Thus, as object requests are processed to generate different object distribution options and as object distribution options are selected or disregarded by recipients 210, the distribution preference algorithm 304 may be continuously re-trained or otherwise updated.

When the recipient selects an object distribution option for their object request, the object distribution system associated with the object request may transmit an object distribution request to the object distribution orchestration system 204 to identify a set of object distribution times for the distribution system nodes that may perform the object distributions to the object distribution processor 206, as described above. Thus, the distribution consolidation algorithm 302 and the distribution preference algorithm 304 may continuously, and in real-time, process incoming object requests and object distribution requests from recipients 210 and object distribution systems 208, respectively, to enable consolidation of different objects associated with different object requests as these different object requests are received.

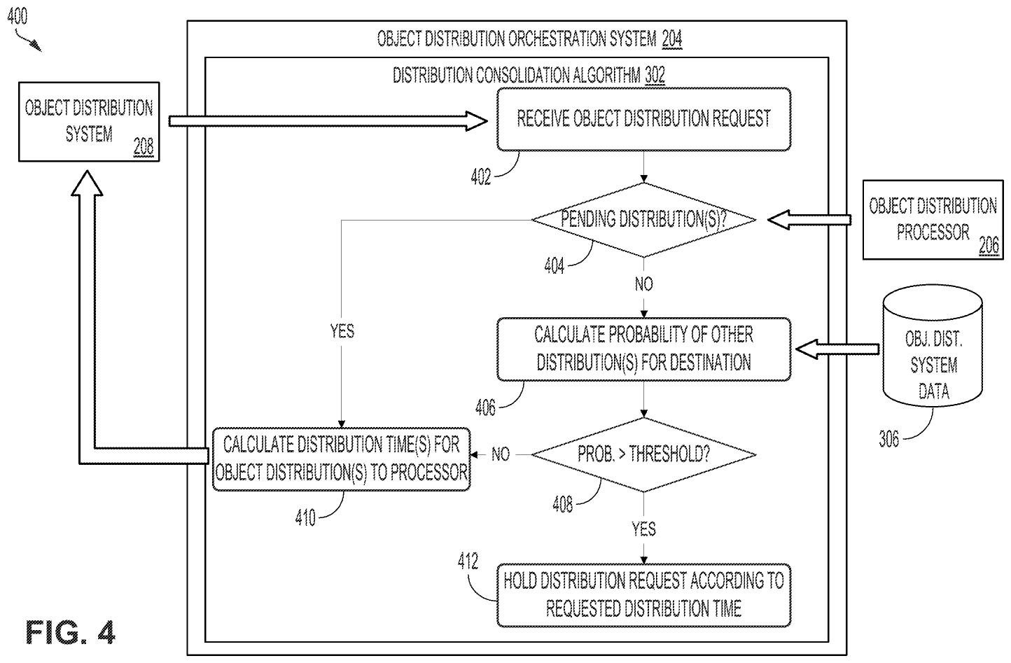

FIG. 4 shows an illustrative example of an environment 400 in which a distribution consolidation algorithm 302 is dynamically trained to calculate different node distribution times for object distributions to an object distribution processor 206 in response to a received object distribution request in accordance with at least one embodiment. In the environment 400, and as noted above, the object distribution orchestration system 204 may implement a distribution consolidation algorithm 302 that is dynamically trained, in real-time, to simultaneously and continuously process incoming object distribution requests from different object distribution systems 208 to generate different object distribution times for the distribution system nodes associated with these different object distribution systems 208.

At step 402, the distribution consolidation algorithm 302 may receive an object distribution request from an object distribution system 208. The object distribution request may be provided to the distribution consolidation algorithm 302 in response to an object request from a recipient for one or more objects that are to be distributed at a specified destination. The object distribution request may specify any target distribution times specified by the recipient (e.g., a specific target distribution time, a target range of distribution times, etc.) and a destination for distribution of the objects associated with the recipient's object request. Additionally, the object distribution request may indicate which distribution system nodes associated with the object distribution system are to be utilized to transmit the objects associated with the object request to the object distribution processor 206 for distribution to the recipient at the specified destination. In some instances, the object distribution system 208 may further provide, in its object distribution request, any applicable parameters that may denote any limitations or constraints applicable to the designated destination system nodes.

At step 404, the distribution consolidation algorithm 302 may determine whether there are any pending object distributions scheduled to be performed at or in proximity to the destination indicated in the object distribution request. For instance, the distribution consolidation algorithm 302 may automatically query the object distribution processor 206 to determine whether there are any scheduled object distributions associated with the indicated destination and to obtain any available transit data maintained by the object distribution processor 206. Additionally, the distribution consolidation algorithm 302 may obtain any available data from the object distribution system datastore 306 corresponding to the identified distribution system nodes and to any other pending object distributions corresponding to the recipient that may be associated with any other object distribution systems to identify any opportunities for consolidating the objects corresponding to the object distribution request with other objects that are to be distributed to the destination indicated by the recipient.

If the distribution consolidation algorithm 302 determines that the current object request can be merged with a pending object distribution associated with the object distribution system 208 or any another object distribution system that is to be made to the same destination, the distribution consolidation algorithm 302 may, at step 410, automatically calculate a set of object distribution times for the distribution system nodes associated with the current object request. This set of object distribution times may allow for consolidation of these objects along with the objects associated with the pending object distribution into a single distribution by the object distribution processor 206. Thus, the distribution consolidation algorithm 302 may automatically provide these calculated object distribution times to the object distribution system 208, which may transmit object distribution requests including these times to the target distribution system nodes to begin transmission of the objects associated with the object request to the object distribution processor 206 for consolidation.

If the distribution consolidation algorithm 302 determines that there are no pending distributions or that otherwise there are no present opportunities for consolidation of the objects associated with the request with other objects corresponding to pending object distributions, the distribution consolidation algorithm 302, at step 406, may calculate the probability of other object distributions being made for the destination. The probability may correspond to a likelihood of new object requests being received that would allow for consolidation of objects associated with the current object request and objects associated with these new object requests without affecting the target object distribution time associated with the current object request. Thus, the probability may correspond to a time window during which object requests may be received to allow for consolidation of object distributions associated with these object requests and the current object request. This probability may be calculated based on prior object distribution data associated with the recipient and/or destination indicated in the object distribution request. For example, if a recipient frequently submits object requests to different object distribution systems for which object distributions are made on Fridays, and the newly received object distribution request corresponds to an object request with a target object distribution time range that includes a Friday, the distribution consolidation algorithm 302 may determine that the probability of another object being distributed to the recipient on that Friday is particularly high.

As noted above, the calculated probabilities for receiving new object requests for the indicated destination may be subject to a pre-defined threshold. Thus, at step 408, the distribution consolidation algorithm 302 may determine whether the calculated probabilities exceed this pre-defined threshold. If the calculated probabilities do not exceed this pre-defined threshold, the distribution consolidation algorithm 302, at step 410, may proceed to calculate the object distribution times for the distribution system nodes specified in the object distribution request and subject to the target distribution time indicated by the recipient, as described above. However, if the distribution consolidation algorithm 302 determines that another object request is likely to be received that would allow for consolidation of the current object request with this other object request subject to the specified target distribution time, the distribution consolidation algorithm 302, at step 412, may hold the current object distribution request for a period of time up to the expected time at which the new object request is predicted to be received. If a new object request is not received by this expected time, the distribution consolidation algorithm 302 may proceed to calculate the object distribution times for the distribution system nodes specified in the object distribution request and subject to the target distribution time indicated by the recipient, as described above.

As noted above, the distribution consolidation algorithm 302 is dynamically trained and updated, in real-time, as different requests associated with different object distribution systems are submitted to the object distribution optimization system for generation of object distribution times for the myriad distribution system nodes associated with these different object distribution systems. The distribution consolidation algorithm 302 may simultaneously, and continuously, process different requests from different object distribution systems and corresponding to different object requests submitted by myriad recipients to provide object distribution times for the distribution system nodes associated with these different object distribution systems. Further, as these object distribution times are provided to these different object distribution systems and as objects associated with different object requests are distributed to the recipients by the object distribution processor, any feedback received corresponding to these provided object distribution times may be used to dynamically, and in real-time, re-train or otherwise update the distribution consolidation algorithm. Thus, while the operations described above are illustrated in FIG. 4 as being performed for a single object distribution request from a single object distribution system 208, these operations may be performed simultaneously and continuously for myriad object distribution systems and for any number of object distribution requests such that the distribution consolidation algorithm 302 is constantly, and in real-time, generating object distribution times for new requests from the different object distribution systems and continuously being re-trained or otherwise updated as feedback is received corresponding to object distribution times provided in response to these requests.

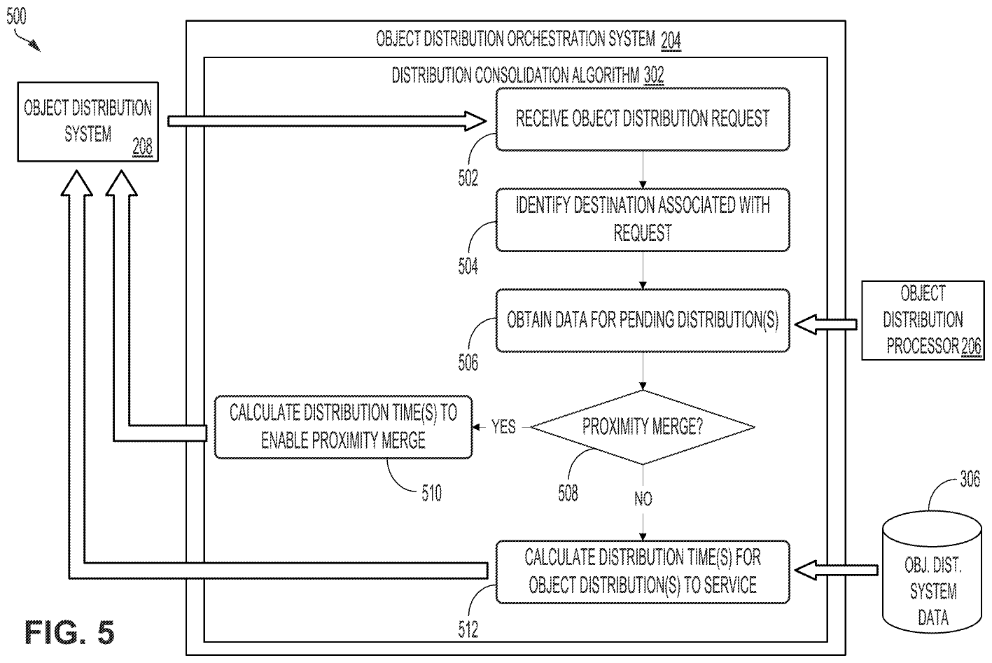

FIG. 5 shows an illustrative example of an environment 500 in which a distribution consolidation algorithm 302 is dynamically trained to calculate different node distribution times for object distributions to an object distribution processor 206 based on any identified merge opportunities for distributions according to destination proximity in accordance with at least one embodiment. In the environment 500, the distribution consolidation algorithm 302, at step 502, may receive an object distribution request. As noted above, the object distribution request may specify any target distribution times specified by the recipient (e.g., a specific target distribution time, a target range of distribution times, etc.) and a destination for distribution of the objects associated with the recipient's object request. Additionally, the object distribution request may indicate which distribution system nodes associated with the object distribution system are to be utilized to transmit the objects associated with the object request to the object distribution processor 206 for distribution at the specified destination. The object distribution system 208 may further provide, in the object distribution request, any applicable parameters that may denote any limitations or constraints applicable to the designated destination system nodes.

In an embodiment, the distribution consolidation algorithm 302 is further dynamically trained, in real-time, to identify any opportunities for merging an object distribution associated with an object request with other object distributions that are scheduled to be made at the specified destination and/or to other destinations that are in relative proximity to the specified destination (e.g., within a spatial radius of the destination, associated with a particular distribution path that includes the destination as defined by the object distribution processor 206, etc.). For example, if the specified destination in an object request corresponds to a destination cluster for which the object distribution processor 206 may perform a single distribution of objects corresponding to recipients associated with this destination cluster, opportunities may be present to merge an object distribution associated with the destination specified in the object request with other object distributions that are to be made to other destinations associated with the common destination cluster. As another illustrative example, if the specified destination in the object request corresponds to a particular destination path that includes various destinations for which the object distribution processor 206 may consolidate objects for a single cluster of object distributions to be performed along the destination path, opportunities may be present to merge an object distribution associated with the destination specified in the object request with other object distributions that are to be made to other destinations along the distribution path in a single cluster of object distributions.

The dynamic and real-time training of the distribution consolidation algorithm 302 for identifying opportunities to merge object distributions at the object distribution processor 206 for consolidated distribution of objects along a destination path or within a destination cluster may be performed using supervised training techniques. For instance, a dataset of input object requests (e.g., prior object requests associated with different recipients, hypothetical object requests generated for training of the distribution consolidation algorithm 302, etc.), distribution data associated with the object distribution processor 206 (e.g., prior object distributions and corresponding destinations, destination path information, destination cluster information, etc.), and known object distribution times for different distribution system nodes associated with the input object requests (e.g., prior object distribution times for actual distribution system nodes associated with prior object requests, hypothetical object distribution times for different distribution system nodes associated with hypothetical object requests, etc.) can be selected for training of the distribution consolidation algorithm 302. Additionally, the dataset may include any applicable parameters and/or performance characteristics associated with the different distribution system nodes that may be used for object distributions. The distribution data, as well as the parameters and/or performance characteristics and the known object distribution times may be used to define a ground truth for dynamic evaluation of the distribution consolidation algorithm 302 to determine whether the distribution consolidation algorithm 302 is accurately identifying any available opportunities for merging object distributions made along a single destination path or to a single destination cluster, thereby reducing the number of object distributions made by the object distribution processor 206.

At step 504, the distribution consolidation algorithm 302 may automatically evaluate the obtained object distribution request to identify the destination associated with the object distribution request. Further, at step 506, the distribution consolidation algorithm 302 may query the object distribution processor 206 to obtain any available data corresponding to any pending object distributions that are to be performed by the object distribution processor 206. This data may include information corresponding to the destinations associated with the pending object distributions, any association between these destinations and different destination paths or clusters, and the available capacity for each object distribution that is to be performed by the object distribution processor 206 for a given destination path or cluster. For example, if the object distribution processor 206 is to perform an object distribution at a particular destination cluster, the object distribution processor 206 may indicate whether additional objects may be added to this object distribution for the destination cluster. The data may further indicate the distribution times corresponding to each of these scheduled object distributions.

At step 508, based on the obtained data from the object distribution processor 206 and the parameters associated with the object distribution request (e.g., the target object distribution time for the underlying object request, parameters associated with the distribution system nodes assigned to distribute the objects to the object distribution processor 206, etc.), the distribution consolidation algorithm 302 may determine whether an opportunity exists to merge the objects associated with the object distribution request with other objects associated with pending object distributions that are to be performed by the object distribution processor 206 for a given destination path or cluster. For example, if an object distribution is to be performed by the object distribution processor 206 on a particular time to a destination cluster that includes the destination specified in the object distribution request, the distribution consolidation algorithm 302 may determine the available capacity for the object distribution to determine whether it satisfies a pre-defined threshold. The pre-defined threshold may correspond to a minimum level of capacity that may be available for an object distribution such that adding one or more objects to the object distribution may consume this available capacity and, thus, potentially reduce the number of object distributions that may be performed by the object distribution processor 206 for the particular destination path or cluster. The threshold may be alternatively determined based on the number of objects associated with the present object distribution request that are to be distributed at the specified destination. For example, if the object distribution request is associated with N objects that are to be distributed, the threshold may be set such that the required available capacity for enabling a proximity merge is a value greater than (up to a maximum amount) or equal to N.

If the distribution consolidation algorithm 302 identifies an opportunity to merge the objects associated with the object distribution request with a pending object distribution for a destination path or cluster corresponding to the destination indicated in the object distribution request, the distribution consolidation algorithm 302, at step 510, may calculate the object distribution times for the distribution system nodes specified in the object distribution request and subject to the distribution time associated with the object distribution that the one or more objects are to be added to. This set of object distribution times may allow for consolidation of these objects along with the objects associated with the pending object distribution to be performed by the object distribution processor 206 at a destination cluster or along a destination path. Thus, the distribution consolidation algorithm 302 may automatically provide these calculated object distribution times to the object distribution system 208, which may transmit object distribution requests including these times to the target distribution system nodes to begin transmission of the objects associated with the object request to the object distribution processor 206 for consolidation.

If the distribution consolidation algorithm 302 determines that there are no current opportunities to merge the objects associated with the object distribution request with a pending distribution that is to be performed by the object distribution processor 206, the distribution consolidation algorithm 302, at step 512, may calculate the object distribution times for the distribution system nodes specified in the object distribution request and subject to the target distribution time specified by the recipient in their object request. This process for calculating these distribution times may be similar to that of step 410 described above in connection with the process illustrated in FIG. 4. In some instances, the distribution consolidation algorithm 302 may further perform the other operations described above in connection with FIG. 4 to identify any opportunities to merge the object distribution of these objects with other pending object distributions that may be associated with the indicated destination, as described above.

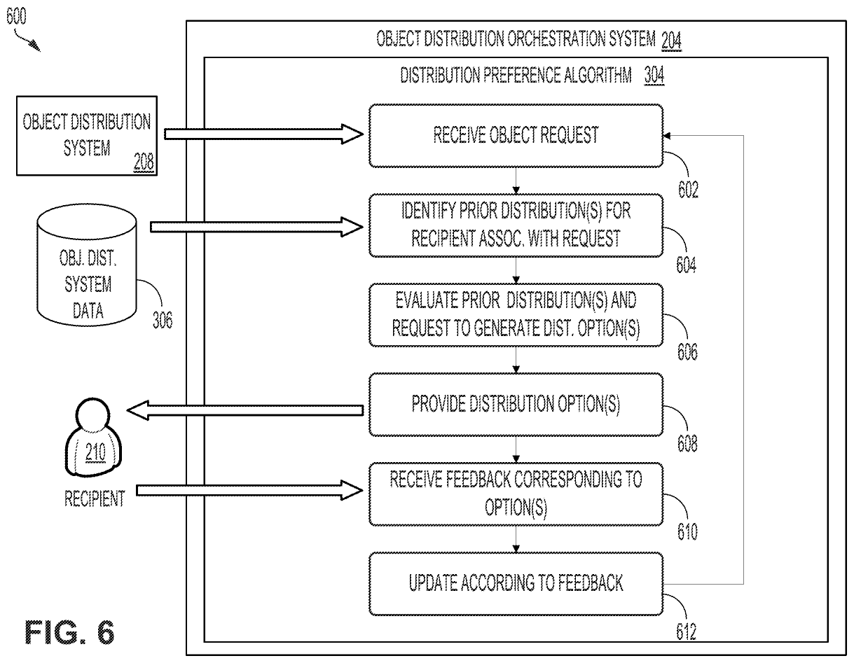

FIG. 6 shows an illustrative example of an environment 600 in which a distribution preference algorithm 304 is dynamically trained to provide tailored object distribution options for a pending object distribution request based on prior object distributions in accordance with at least one embodiment. In the environment 600, and as noted above, the object distribution orchestration system 204 may implement a distribution preference algorithm 304 that is dynamically trained, in real-time, to provide, through the object distribution systems, different object distribution options corresponding to different target object distribution times or time ranges for distribution of objects to recipients at their indicated destinations.

At step 602, the distribution preference algorithm 304 may receive an object request from an object distribution system 208. The object request may indicate a destination to which an object distribution is to be performed for the objects included in the object request. Further, the object request may include identifying information associated with the intended recipient of these objects. The identifying information may include, but is not limited to, a username, a legal name, a network address (e.g., electronic mail address, etc.), destination information, and the like. Additionally, the object request may indicate any recipient time preferences for object distributions (e.g., preferred time(s) of day for distributions, specific preferred day(s) for distributions, etc.).

At step 604, the distribution preference algorithm 304 may automatically query the object distribution system datastore 306 to identify any prior object distributions performed for the recipient associated with the object request. As noted above, the distribution preference algorithm 304 may obtain, from the object distribution system datastore 306, prior data and preferences for each recipient associated with the various object distribution systems associated with the object distribution optimization system. This prior data may include previous object requests fulfilled by the object distribution systems, destinations to which object distributions were provided to recipients, the object distribution options selected by recipients for each previous object request, and the like. The prior data and preferences, as noted above, may be used to construct the dataset that is used to dynamically train the distribution preference algorithm 304 to identify any recipient preferences that may be surfaced to recipients in response to their object requests.

At step 606, the distribution preference algorithm 304 may evaluate the prior object distributions and the current object request, in real-time, to generate a set of object distribution options that may be surfaced to the recipient 210. As noted above, the object distribution options may correspond to different target object distribution times or time ranges for distribution of the objects associated with the object request. For instance, a particular object distribution option may correspond to a target object distribution time that represents the fastest possible distribution of the requested objects to the recipient's indicated destination, subject to any parameters defined by the corresponding object distribution system and the transit data associated with the object distribution processor. As another illustrative example, an object distribution option may correspond to a target object distribution time that allows for consolidation of the objects associated with the object request with other objects corresponding to pending object distributions associated with the specified destination. As yet another illustrative example, an object distribution option may allow the object distribution system 208 to dynamically select a target object distribution time that allows for consolidation of a maximum number of objects into a single distribution to the destination indicated by the recipient 210. The evaluation of the prior object distributions may allow the distribution preference algorithm 304 to dynamically, and in real-time, identify any object distribution preferences and/or patterns/trends that may be used to generate the object distribution options, as described above.

At step 608, the distribution preference algorithm 304 may provide the generated object distribution options to the recipient 210 through the object distribution system 208. For example, the object distribution system 208, upon obtaining these generated object distribution options, may update a graphical user interface (GUI) through which the object request was submitted by the recipient 210 to provide the generated object distribution options. This may allow the recipient 210 to review the available object distribution options and select any of these object distribution options or any other object distribution options that may be available to the recipient 210 but otherwise not recommended by the distribution preference algorithm 304. In some instances, the generated object distribution options may be provided with one or more incentives to entice the recipient 210 to select from these object distribution options. For example, if a particular object distribution option would allow for consolidation of the objects associated with the object request with other objects associated with other object distributions that are to be performed at the destination indicated by the recipient 210, the distribution preference algorithm 304 may indicate that the object distribution option is to be provided with an incentive (e.g., reduced resource requirements from the recipient 210, reduced resource requirements for future object requests, etc.).

At step 610, the distribution preference algorithm 304 may receive feedback corresponding to the provided object distribution options, which, at step 612, may be used to dynamically update the distribution preference algorithm 304. As noted above, if a recipient 210 foregoes selecting any of the provided object distribution options and instead selects an alternative object distribution option not provided by the distribution preference algorithm 304, the distribution preference algorithm 304 may be dynamically updated in real-time such that, for similar recipients and/or object requests, the distribution preference algorithm 304 may be less likely to provide or otherwise prominently present these options. Further, the distribution preference algorithm 304, for similar recipients and/or object requests, may be dynamically trained to increase the likelihood of the selected distribution option being prominently presented or otherwise provided to these similar recipients and/or for the similar object requests. Alternatively, if the recipient 210 selects a particular option provided by the distribution preference algorithm 304, the distribution preference algorithm 304 may be dynamically updated in real-time such that, for similar recipients and/or object requests, the distribution preference algorithm 304 may provide this particular object distribution option.

As noted above, the distribution preference algorithm 304 is dynamically trained, in real-time, as different object requests associated with different recipients are obtained. For example, the distribution preference algorithm 304 may simultaneously, and continuously, process different object requests associated with different recipients to provide different object distribution options to these different recipients. Further, as these different object distribution options are provided to these different recipients, any feedback (e.g., selections, etc.) received corresponding to these different object distribution options for the corresponding object requests may be used to dynamically, and in real-time, re-train or otherwise update the distribution preference algorithm 304. Thus, as object requests are processed to generate different object distribution options and as object distribution options are selected or disregarded by recipients, the distribution preference algorithm 304 may be continuously re-trained or otherwise updated.

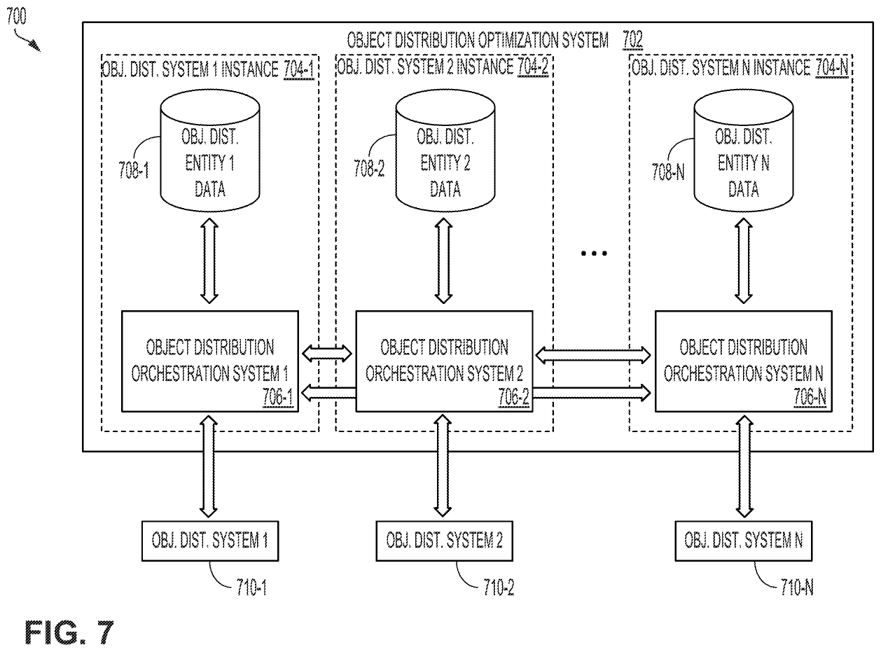

FIG. 7 shows an illustrative example of an environment 700 in which an object distribution optimization system 702 is implemented using a multi-tenant infrastructure to allow multiple object distribution systems 710-1-710-N to utilize the object distribution optimization system 702 concurrently in accordance with at least one embodiment. In the environment 700, the object distribution optimization system 702 may be implemented in a cloud environment that is scalable to support the requirements of the object distribution optimization system 702. The cloud environment may be provided by a computing resource service provider that offers high availability, resilience, fault tolerance, and other critical enterprise-grade capabilities to allow for multi-tenant use of the object distribution optimization system 702 by various object distribution systems 710-1-710-N.

Each object distribution system 710-1-710-N may interact with its own instance 704-1-704-N, respectively, of the object distribution optimization system 702. These instances 704-1-704-N may be implemented as virtual machine instances, virtualized containers, or other virtualized resources made available by a computing resource service provider that implements the cloud environment for the object distribution optimization system 702. As the demand for use of the object distribution optimization system 702 increases (e.g., additional object distribution systems are accessing the object distribution optimization system 702), the computing resource service provider may provision additional instances to support this additional demand for these object distribution systems. Thus, the resources utilized by the object distribution optimization system 702 may scale automatically with the increase in demand or load on the object distribution optimization system 702.

In an embodiment, each instance 704-1-704-N includes an object distribution orchestration system 706-1-706-N and object distribution system datastore 708-1-708-N. An object distribution orchestration system may be configured to process incoming requests from an object distribution system to identify one or more object distribution times for an object request submitted to the object distribution system by a recipient. Further, the object distribution orchestration system may provide object distribution times for each of the distribution system nodes associated with the object distribution system that are to collectively fulfill the object request. These object distribution times may be determined based on the transit times from the distribution system nodes to a local object distribution processor endpoint (e.g., hub, distribution center, etc.) from which an object distribution may be performed for a recipient. Further, these object distribution times may be determined such that objects from these distribution system nodes arrive at the local object distribution processor endpoint at a time that allows the object distribution processor to consolidate these objects into a single object distribution that can be performed on a particular time as specified by the recipient, determined by the object distribution system, or determined by the object distribution orchestration system.

The object distribution system datastore 708-1-708-N may include information specific to the corresponding object distribution system 710-1-710-N, respectively, that may be used by the object distribution orchestration system 706-1-706-N to identify the object distribution times for each distribution system node associated with the corresponding object distribution system 710-1-710-N, as well as possible object distribution times for object requests based on recipient preferences and prior data. For instance, an object distribution system datastore may include prior data and preferences for each recipient associated with an object distribution system. This prior data may include previous object requests fulfilled by the object distribution system, destinations to which object distributions were performed for the recipient, the object distribution options selected by the recipient for each previous object request, and the like. Further, the object distribution system datastore may include performance metrics for each of the distribution system nodes associated with the object distribution system. These performance metrics may include a score corresponding to the rate at which a distribution system node is able to transmit objects to the object distribution processor on time and as scheduled. Further, the performance metrics may indicate a score corresponding to the rate at which object distributions to the indicated destination were made according to the object distribution time provided to the recipient as opposed to other times, whether prior to or after the object distribution time provided to the recipient. The performance metrics and prior data from the object distribution system datastore may be used by the object distribution orchestration system to determine the object distribution times for each distribution system node associated with the object distribution system that is to fulfill an object request associated with a recipient to ensure that the objects from these nodes arrive at a local object distribution processor endpoint for consolidation and distribution to the recipient at a time indicated to the recipient by the object distribution system. As noted above, the data obtained from the object distribution system datastore may be used as input to a machine learning algorithm or artificial intelligence to dynamically, and in real-time, generate these object distribution times.

In an embodiment, each object distribution orchestration system 706-1-706-N may be in communication with the other object distribution orchestration systems of the object distribution optimization system 702 to identify potential efficiencies for consolidating object distributions among different object distribution systems 710-1-710-N. For instance, given an object distribution time for an object request provided by an object distribution system, the object distribution orchestration system may automatically query, in real-time, the other object distribution orchestration systems of other object distribution system instances to determine whether other object distributions are scheduled to occur at the destination specified in the object request. If so, the object distribution orchestration system may determine the one or more times of these other object distributions and, based on these one or more times, identify any potential opportunities for consolidating the object request with any of the one or more other object distributions for other object distribution systems to the recipient at the specified destination. These opportunities may be presented to the recipient via the object distribution system in the form of alternative object distribution times. Further, to incentivize these alternative object distribution times, the recipient may be provided with certain incentives for selecting one of these alternative object distribution times for their object request. In an embodiment, these opportunities, corresponding object distribution times, and options may be generated using the distribution consolidation algorithm and distribution preference algorithm, as described above.

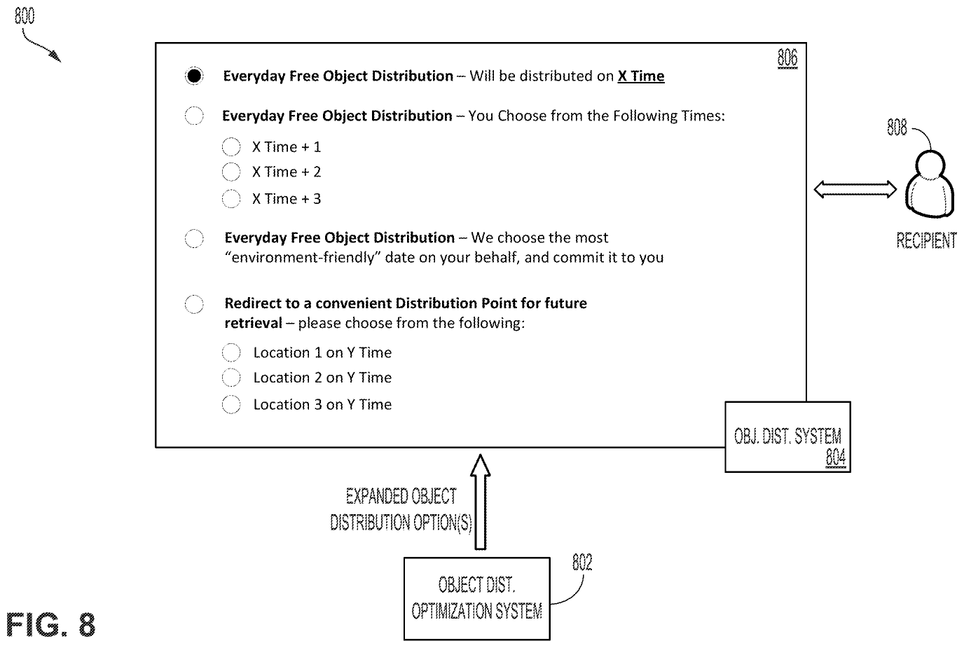

FIG. 8 shows an illustrative example of an environment 800 in which an object distribution system 804 provides, through a GUI 806, a set of expanded options to a recipient 808 for consolidating object distributions on a particular object distribution time in accordance with at least one embodiment. In the environment 800, a recipient 808 associated with the object distribution system 804 may initiate an object request for one or more objects that are to be distributed to the recipient 808 via an object distribution processor. In an embodiment, the object distribution system 804 is in communication with an object distribution optimization system 802 in order to identify preferred object distribution times for consolidation of objects from one or more distribution system nodes associated with the object distribution system 804 and of objects from other object distribution systems that are to be distributed to the destination indicated by the recipient 808 to the object distribution system 804 for distribution of its objects.

In an embodiment, in response to receiving a proposed object request from a recipient 808, the object distribution system 804 determines which distribution system nodes can be used to fulfill the object request and transmit the objects associated with the object request to the object distribution processor for distribution to the recipient 808. For instance, the object distribution system 804 may identify, for each object selected by the recipient 808, which distribution system node maintains the object and is assigned with transmitting the object to the recipient 808. These distribution system nodes may be located in different regions and, thus, may have different transit times to the object distribution processor at a local object distribution processor endpoint associated with the region including the destination indicated by the recipient 808. The object distribution system 804 may provide the proposed object request and the object distribution requests for the identified distribution system nodes to the object distribution optimization system 802 to automatically, and in real-time, identify a set of possible object distribution times for fulfillment of the proposed object request from the recipient 808.

In response to obtaining the proposed object request and the object distribution requests for the identified distribution system nodes, the object distribution optimization system 802 may automatically, and in real-time, generate one or more possible object distribution times for fulfillment of the proposed object request. The object distribution optimization system 802 may obtain transit data from an object distribution processor that may provide transit times from various origin points to different local object distribution processor endpoints. To obtain this transit data, the object distribution optimization system may transmit a request to the object distribution processor to retrieve the transit data specific to the region that includes the destination provided by the recipient. In this request, the object distribution optimization system may provide the destination specified by the recipient in their object request. Alternatively, the object distribution optimization system may provide information corresponding to this destination (e.g., a code, a local object distribution processor endpoint at or near the destination provided by the recipient, etc.). In some instances, the object distribution optimization system may access a system or other provided by the object distribution processor to obtain the transit data. In an embodiment, the object distribution optimization system maintains the transit data provided by the object distribution processor and, thus, may refer to the transit data locally. The transit data may be updated periodically or in response to a triggering event (e.g., impacts to the object distribution processor resulting from an event, etc.).

The transit data provided by the object distribution processor or otherwise maintained by the object distribution optimization system 802 may indicate the transit times for objects from different origin points to each of the local object distribution processor endpoints from which object distributions may be perform within a particular area. In an embodiment, the object distribution optimization system 802 evaluates the transit data to determine, for each distribution system node that is to fulfill the proposed object request, the transit time for an object from the distribution system node to the local object distribution processor endpoint that is associated with the destination indicated by the recipient 808. Since the distribution system nodes associated with the object distribution system may be located in different locations, the transit times for these distribution system nodes to the local object distribution processor endpoint may differ.

Based on the transit data, the destination indicated by the recipient 808, and the location of each distribution system node that may be tasked to fulfill the proposed object request, the object distribution optimization system 802 may identify one or more possible object distribution times for the object request. For instance, based on the identified transit times for each of the distribution system nodes, the object distribution optimization system 802 may identify the earliest time in which the objects from these distribution system nodes may arrive at the local object distribution processor endpoint for consolidation and distribution to the recipient 808 at the specified destination. The object distribution optimization system 802 may provide this identified object distribution time to the object distribution system 804, which may present this object distribution time to the recipient 808 via the GUI 806.

In an embodiment, the object distribution optimization system 802 can identify additional object distribution times for fulfillment of the object request based on pending object distributions to be performed according to the destination provided by the recipient 808. These pending object distributions may correspond to other object requests submitted by the recipient 808 via the object distribution system 804 and other object distribution systems. For instance, the object distribution optimization system 802 may query the object distribution processor to determine whether there are any pending object distributions scheduled for the destination indicated by the recipient 808. If so, the object distribution optimization system 802 may identify the one or more times for these pending object distributions. Using these one or more times, the object distribution optimization system 802 may determine whether the proposed object request may be consolidated with these pending object distributions. For instance, if the one or more times are after the earliest time in which the proposed object request can be fulfilled, the object distribution optimization system 802 may determine that the proposed object request may be consolidated with the pending object distributions to allow for consolidated object distribution on any of the one or more times. However, if the one or more times are prior to the earliest time in which the proposed object request can be fulfilled, the object distribution logistics system 802 may determine that consolidation of the proposed object request with other pending object distributions is not possible.

In an embodiment, in addition to identifying any pending object distributions that may be scheduled for the address indicated by the recipient 808, the object distribution optimization system 802 can identify any pending object distributions scheduled for object distribution points associated with the object distribution processor that may be located near the destination indicated by the recipient 808. For instance, if the recipient 808 has scheduled object distribution of one or more objects at a particular object distribution point, the object distribution optimization system 802 may identify the scheduled time for this object distribution and determine whether this time is prior to or after the earliest time identified by the object distribution optimization system 802 for obtaining the objects from the one or more distribution system nodes associated with the object distribution system 804. If consolidation of the proposed object request with the scheduled object distribution may be performed, the object distribution optimization system 802 may provide, to the object distribution system 804, this proposed time and object distribution point location as a possible object distribution option for the recipient 808.

Through the GUI 806, the object distribution system 804 may provide the recipient 808 with the various object distribution time options identified by the object distribution optimization system 802. For instance, through the GUI 806, the object distribution system 804 may provide the recipient 808 with an option to have their proposed object request fulfilled by the earliest time identified by the object distribution optimization system 802 subject to no additional resource requirements. Additionally, through the GUI 806, the object distribution system 804 may provide the recipient 808 with any additional object distribution times that may correspond to object distribution times for other pending object distributions that may be consolidated with the proposed object request. As illustrated in FIG. 8, the recipient 808 may also be provided with an option to defer to the object distribution system 804 and the object distribution optimization system 802 to select an object distribution time for the proposed object request on the recipient's behalf. This may provide the object distribution optimization system 802 with flexibility in identifying an efficient manner in which to consolidate the proposed object request with pending object distributions to allow for a single object distribution to the specified destination on a particular time. The object distribution system 804 may also provide the recipient 808 with an option to redirect object distribution of the proposed object request to a particular object distribution point associated with the object distribution processor that may be near to the destination provided by the recipient 808 and/or to which a pending object distribution is scheduled to be made.

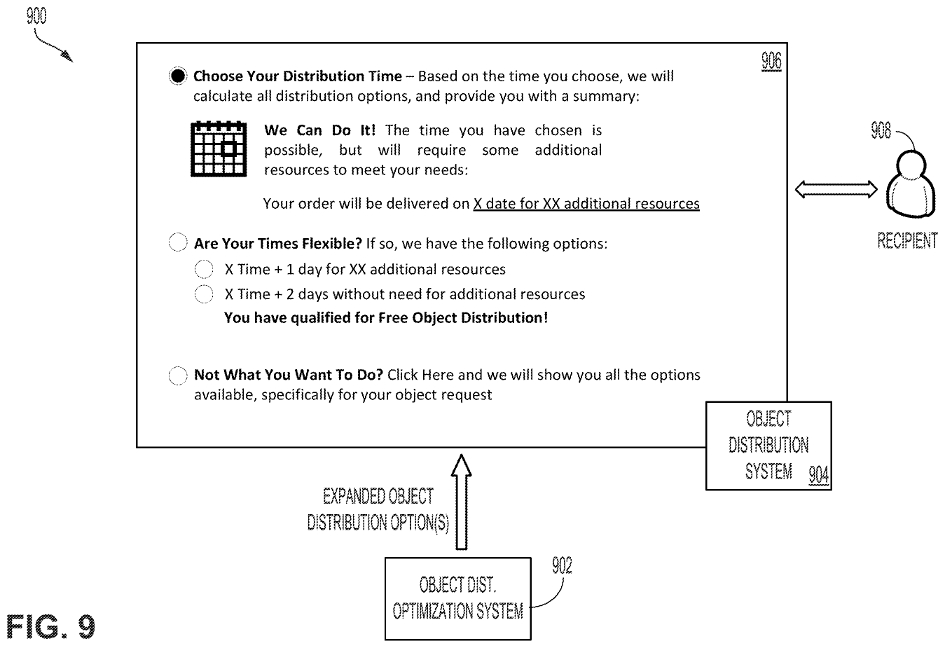

FIG. 9 shows an illustrative example of an environment 900 in which an object distribution system 904 provides, through a GUI 906, a set of specific time selection options to a recipient 908 for consolidating object distributions on a specific time in accordance with at least one embodiment. In the environment 900, a recipient 908 associated with the object distribution system 904 may initiate an object request for one or more objects that may be distributed to the recipient 908 via an object distribution processor. As with the object distribution system 804 described above in connection with FIG. 8, the object distribution system 904 may be in communication with an object distribution optimization system 902, which may operate to provide the object distribution system 904 with various object distribution options and times that may be presented to the recipient 908 to allow the recipient 908 to determine its preferred method of object distribution.

In an embodiment, the object distribution system 904, via the GUI 906, provides the recipient 908 with an option to select their preferred object distribution day for the objects selected by the recipient 908 through the object distribution system 904. For instance, through the GUI 906, the recipient 908 may be presented with various times from which the recipient 908 may select a preferred time for object distribution of the objects in the object request to be submitted to the object distribution system 904. If the recipient 908 selects a preferred time for distribution of the objects, the object distribution system 904 may transmit this preferred time, as well as the destination to which the distribution of the objects is to be performed and the location of any distribution system nodes that may be used to fulfill the object request, to the object distribution optimization system 902 to determine whether this object distribution time is feasible. For instance, the object distribution optimization system 902 may evaluate the transit data associated with the object distribution processor to determine whether objects from the one or more distribution system nodes can be delivered to the local object distribution processor endpoint for consolidation in time to satisfy the recipient's specified object distribution time.

If the object distribution optimization system 902 determines that the object distribution time selected by the recipient 908 is feasible, the object distribution optimization system 902 may determine whether additional resources are required in order to satisfy this object distribution time. For instance, if satisfying the object distribution time would require additional object distribution processor resources in order to fulfill the object request, the object distribution optimization system 902 may identify, from the object distribution processor, the additional resources that may be required from the recipient 908 in order to fulfill the object request. Details regarding this additional resources may be provided to the object distribution system 904, which may present an indication of these additional resources to the recipient 908 via the GUI 906.

In an embodiment, the object distribution optimization system 902 can identify other objects from other object distribution systems that are pending distribution to the recipient 908 on alternative times. For instance, using the destination provided by the recipient 908 to the object distribution system 904, the object distribution optimization system 902 may query the object distribution processor to determine whether any other object distributions are scheduled for this destination. Additionally, or alternatively, the object distribution optimization system 902 may evaluate other object requests from the object distribution system 904 and other object distribution systems to determine whether any of these other object requests are associated with the destination provided by the recipient 908. If the object distribution optimization system 902 determines that other objects are scheduled for distribution to the destination provided by the recipient 908, the object distribution optimization system 902 may identify the corresponding object distribution times for each of these objects. Further, the object distribution optimization system 902 may determine whether there are any opportunities for consolidation of the object request being generated by the recipient 908 via the GUI 906 with the pending object distributions corresponding to these other objects. If the object distribution optimization system 902 identifies one or more opportunities for consolidation of the object request with pending object distributions scheduled for the recipient 908, the object distribution optimization system 902 may provide the times corresponding to these opportunities to the object distribution system 904 for presentation to the recipient 908 as alternative object distribution times for their object request.

In an embodiment, if the object distribution optimization system 902 identifies opportunities for consolidation of the object request with other pending object distributions for the recipient 908, the object distribution optimization system 902 can provide the recipient 908 with incentives to alter their preferred object distribution time as specified via the GUI 906 with an object distribution time corresponding to these other pending object distributions that may allow for consolidation of the object request with these pending object distributions. For instance, as illustrated in FIG. 9, the object distribution optimization system 902 may provide the object distribution system 904 with one or more options for alternative object distribution times that may result in a reduced resource requirement for the recipient 908. Through the GUI 906, the object distribution system 904 may present these alternative object distribution times to the recipient 908, as well as the associated resource requirement of object distribution associated with these alternative object distribution times. Through the presentation of any resource efficiencies along with the alternative object distribution time options, the recipient 908 may be encouraged to select an alternative object distribution time, which may allow for consolidation of objects from the object distribution system 904 and other object distribution systems into a single object distribution for the recipient 908.

In some instances, the object distribution optimization system 902 may determine that the time provided by the recipient 908 is not feasible for fulfillment of the object request. For instance, the time selected by the recipient 908 may not allow sufficient time for the distribution system nodes associated with the object distribution system 904 to prepare and provide the various objects to the object distribution processor for distribution to the recipient 908. As a result, the object distribution optimization system 902 may transmit a notification to the object distribution system 904 to indicate that the object request cannot be fulfilled by the selected time. This may cause the object distribution system 904 to indicate, via the GUI 906, that the object request cannot be fulfilled by the specified time. However, the object distribution system 904 may present the recipient 908 with the alternative object distribution times identified by the object distribution optimization system 902 as described above. Further, the recipient 908 may be presented with an option to select a different object distribution time. If the recipient 908 selects a different object distribution time, the object distribution system 904 may provide this different object distribution time to the logistics optimization system 902, which may perform another evaluation as described above to determine whether this different object distribution time is feasible and whether there are any additional opportunities for consolidation of the object request with other pending object distributions from the object distribution system 904 and other object distribution systems.

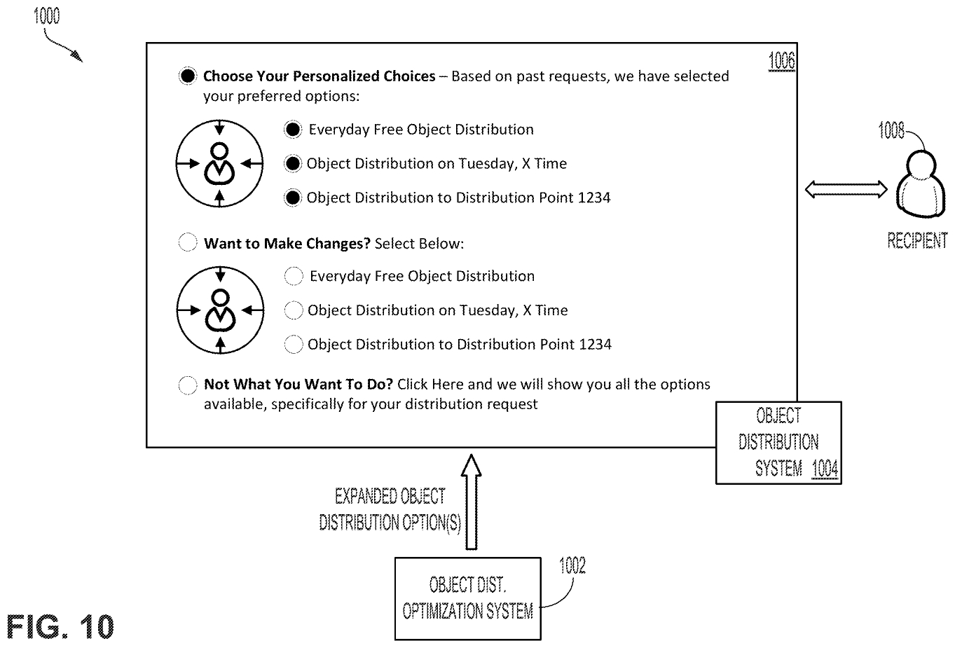

FIG. 10 shows an illustrative example of an environment 1000 in which an object distribution system 1004 provides, through a GUI 1006, a set of tailored object distribution options for consolidated object distributions based at least in part on prior object requests in accordance with at least one embodiment. In the environment 1000, a recipient 1008 associated with an object distribution system 1004 may initiate an object request for one or more objects that may be distributed to the recipient 1008 via an object distribution processor. The object distribution system 1004 may be in communication with an object distribution optimization system 1002, which may operate to provide the object distribution system 1004 with various object distribution options and times that may be presented to the recipient 1008 to allow the recipient 1008 to determine its preferred method of object distribution.

In an embodiment, the object distribution optimization system 1002 maintains prior data associated with the object distribution system 1004 as well as of the recipient 1008. For example, the object distribution optimization system 1002 may maintain prior data corresponding to prior object requests submitted by the recipient 1008 to the object distribution system 1004 that may have been fulfilled by the object distribution system 1004 using the object distribution optimization system 1002. As noted above, in response to obtaining an object request from a recipient 1008, the object distribution system 1004 may interact with the object distribution optimization system 1002 to identify object distribution times for each of the object distribution system's nodes to ensure that the objects from these distribution system nodes can be consolidated for performance of a single object distribution at a specified time to the destination indicated by the recipient in their object request. The object request may include the preferred object distribution timeframe for the recipient 1008, the objects ordered by the recipient 1008, the destination to which the objects are to be distributed, and any other recipient preferences for distribution of the objects (e.g., specific day of the week, etc.). The object distribution optimization system 1002 may maintain, for each recipient 1008, a record of each object request.

As noted above, the object distribution optimization system 1002 may interact with various object distribution systems, including object distribution system 1004. As such, the object distribution optimization system 1002 may maintain, for each recipient 1008, various object requests from different object distribution systems that are pending or have otherwise been fulfilled. Object requests from different object distribution systems may be consolidated such that objects from different object distribution systems may be consolidated at a local object distribution processor endpoint to allow for a single distribution of these objects to the recipient 1008 at a specified destination or distribution endpoint associated with the object distribution processor. The object distribution optimization system 1002 may maintain object requests associated with a recipient 1008 for a period of time, purging any object requests that were submitted beyond an expiration time threshold. This may ensure that contemporaneous object requests are utilized to identify a recipient's preferences.

Through these different object requests, the object distribution optimization system 1002 may identify specific recipient preferences for distribution of their objects from all object distribution systems and/or from specific object distribution systems, such as object distribution system 1004. For instance, as illustrated in FIG. 10, the logistics optimization system 1002 may determine that the recipient 1008 prefers minimizing the amount of resources required from the recipient 1008 for distribution of their objects, with object distributions being made on a Tuesday, and to a particular object distribution endpoint associated with the object distribution processor. These preferences may be identified based on the object requests with various object distribution systems associated with the object distribution optimization system 1002 or with the object distribution system 1004. The preferences may be provided to the object distribution system 1004, which may present these preferences to the recipient 1008 via the GUI 1006 as the recipient 1008 prepares their object request for the object distribution system 1004. As noted above, these preferences may be automatically and dynamically identified, in real-time, by the object distribution optimization system 1002 through a distribution preference algorithm, such as the distribution preference algorithm 304 described above in connection with FIGS. 3 and 6.

In an embodiment, the object distribution system 1004 provides the recipient 1008, through the GUI 1006, with one or more options to deviate from the preferences identified by the object distribution optimization system 1002 and selected by default in the GUI 1006. For instance, as illustrated in FIG. 10, the GUI 1006 may be configured to provide the recipient 1008 with options to change from minimal resource allocation for object distribution, from object distributions being performed on Tuesdays, and/or from object distributions being made to a specific object distribution endpoint associated with the object distribution processor. If the recipient 1008 opts to deviate from the preferences (e.g., tailored object distribution options) identified by the object distribution optimization system 1002, the object distribution system 1004 may note these deviations and provide, in the object request, the recipient's alternative object distribution selections to the object distribution optimization system 1002. As noted above, these object distribution selections may be used to dynamically, and in real-time, re-train or otherwise update the distribution preference algorithm to improve the accuracy of the distribution preference algorithm in generating object distribution selections for recipients associated with the myriad object distribution systems associated with the object distribution optimization system 1002.

Based on the recipient's selections via the GUI 1006, the object distribution optimization system 1002 may revise or reinforce the recipient's preferences maintained in a recipient profile stored by the object distribution optimization system 1002. For example, the object distribution optimization system 1002 may utilize the distribution preference algorithm to identify the recipient's preferences based on prior object requests from the object distribution system 1004 and from other object distribution systems that utilize the object distribution optimization system 1002. As the recipient 1008 submits an increasing number of object requests with the object distribution system 1004 and other object distribution systems that utilize the object distribution optimization system 1002, additional data points may be obtained that can be used to reinforce the training of the distribution preference algorithm implemented and dynamically trained to identify recipient 1008 trends and preferences. For instance, if a recipient 1008 deviates from the personalized choices or preferences presented via the GUI 1006, the object distribution optimization system 1002 may use this deviation as input to the distribution preference algorithm to determine whether the recipient's preferences have changed or whether this deviation is an aberration (e.g., isolated instance). Thus, as additional object requests are processed for the recipient 1008, the object distribution optimization system 1002 may continuously update the recipient's preferences that can be presented to the recipient 1008 by the object distribution system 1004 and other object distribution systems that utilize the object distribution optimization system 1002.

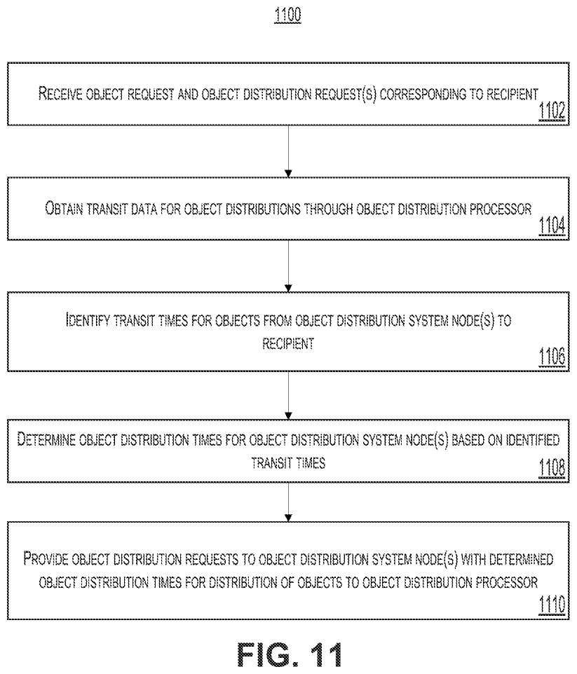

FIG. 11 shows an illustrative example of a process 1100 for determining object distribution times for distribution system nodes associated with an object distribution system based on transit times from the distribution system nodes to an object distribution processor in accordance with at least one embodiment. The process 1100 may be performed by the object distribution optimization system, which may utilize transit data associated with an object distribution processor to determine the transit times from distribution system nodes associated with an object distribution system to the object distribution processor to allow for consolidated distribution of objects to a recipient on a particular time. Further, the process 1100 may be performed in an environment wherein objects specified in an object request obtained by the object distribution system may be associated with different distribution system nodes, whereby each distribution system node may be located in a different region. Further, the process 1100 may be performed independent of interactions of other object distribution systems with the object distribution optimization system or object distribution processor. Thus, the process 1100 may be performed for a single object distribution system that may split objects associated with an object request destined for a recipient among any number of distribution system nodes associated with the object distribution system. However, it should be noted that the process 1100 may be performed by the object distribution optimization system for any number of object distribution systems and corresponding object requests continuously and in real-time as these requests are received.

At step 1102, the object distribution optimization system receives, from an object distribution system, object requests and corresponding object distribution requests associated with a particular recipient. The object requests for a particular recipient may specify the objects requested by the recipient, the resources allocated by the recipient for the objects, an object distribution time or range provided to the recipient by the object distribution system, and the like. The object distribution requests for a particular recipient may include the individual object distribution requests that are to be provided to the one or more distribution system nodes associated with the object distribution system for distribution of a portion of the object request to an object distribution processor for distribution to a destination designated by the recipient. For instance, a portion of an object request may be fulfilled by one node while another portion of the object request may be fulfilled by a different node.

The distribution system nodes associated with the object distribution system may be located in different locations. For instance, each node may be assigned to maintain and transmit certain objects or classes of objects on behalf of the object distribution system. Alternatively, a node may maintain certain objects or classes of objects that are subject to greater demand within a particular region associated with the node. Distribution system nodes may further be located near object distribution processor hubs, through which objects are transited to local object distribution processor endpoints for distribution to recipients. Distribution system nodes may also be located at or near systems that generate or otherwise provide the objects made available by the object distribution system and distributed to its recipients. Thus, a set of objects requested by a recipient may be maintained in different distribution system nodes and in different regions.

In response to receiving the object request and the object distribution requests corresponding to the recipient from the object distribution system, the object distribution optimization system, at step 1104, obtains transit data for object distributions through the object distribution processor to a local object distribution processor endpoint that is to distribute the objects to the destination specified by the recipient in their object request. To obtain this transit data, the object distribution optimization system may transmit a request to the object distribution processor to retrieve the transit data specific to the region that includes the destination indicated by the recipient. In this request, the object distribution optimization system may provide the destination specified by the recipient in their object request. Alternatively, the object distribution optimization system may provide information corresponding to this destination (e.g., a code, a local object distribution processor endpoint in proximity to the destination indicated by the recipient, etc.). In some instances, the object distribution optimization system may access a system or other provided by the object distribution processor to obtain the transit data. In an embodiment, the object distribution optimization system maintains the transit data provided by the object distribution processor and, thus, may refer to the transit data locally. The transit data may be updated periodically or in response to a triggering event (e.g., impacts to the object distribution processor resulting from an event, etc.).

The transit data provided by the object distribution processor or otherwise maintained by the object distribution optimization system may indicate the transit times for objects from different locations to each of the local object distribution processor endpoints from which object distributions may be made within a particular area. For instance, the transit data may indicate the transit time for an object from one particular area to another area or to an object distribution processor endpoint that associated with this other area. In an embodiment, the object distribution optimization system evaluates the transit data to determine, for each distribution system node that is to fulfill the object request by transiting the various objects in the object request to an object distribution processor endpoint for distribution to the recipient, the transit time for an object from the node to the object distribution processor endpoint. As noted above, the distribution system nodes associated with the object distribution system may be located in different locations. Thus, the transit times for these nodes to the object distribution processor endpoint may differ.

At step 1106, the object distribution optimization system may identify the transit times for objects from the distribution system nodes to the object distribution processor endpoint associated with the recipient destination (e.g., an endpoint that is associated with the region that includes the recipient destination). As noted above, the object distribution optimization system may use the obtained transit data to identify the transit times for objects from each of the distribution system nodes to the object distribution processor endpoint that is to complete distribution of these objects to the destination specified by the recipient in their object request. Further, these transit times may differ. For instance, the transit time for an object from one node to the object distribution processor endpoint may be longer or shorter compared to the transit time for another object from another node to the object distribution processor endpoint.

At step 1108, the object distribution optimization system determines the object distribution time for each of the distribution system nodes that are to fulfill the object request based on the identified transit times. For instance, the object distribution optimization system may calculate, based on the identified transit times and the object distribution time provided by the object distribution system to the recipient, a time for each distribution system node to initiate transit of an object associated with the object request such that all objects associated with the object request may arrive at the object distribution processor endpoint for consolidation and distribution to the recipient on the specified object distribution time. For example, if the transit time for a first node is longer than that for a second node, the object distribution optimization system may determine an earlier transit time for the first node in order to ensure that the objects from these distribution system nodes arrive at the object distribution processor endpoint concurrently (e.g., at a time or within a time period that allows for consolidation of objects for performance of a single object distribution to a recipient). Thus, the object distribution times for the distribution system nodes may differ.

In an embodiment, the object distribution optimization system can obtain additional information that may be used to determine the object distribution times. For instance, the object distribution optimization system may obtain information from the object distribution processor that may indicate variances to the transit times provided in the transit data. As an example, in response to a natural disaster that impacts a transit path and/or one or more object distribution processor endpoints, the object distribution processor may provide information that details the estimated delays or lag in the transit times specified in the transit data. In an embodiment, the object distribution optimization system can use the aforementioned distribution consolidation algorithm (e.g., distribution consolidation algorithm 302 described above in connection with FIGS. 3-5) and the transit data to identify an object distribution time for each node. For instance, the distribution consolidation algorithm may utilize the transit data and one or more object distribution metrics (e.g., actual transit times from nodes to different object distribution processor endpoints for previous object requests, statistics denoting variances between estimated and actual transit times, statistics denoting performance of each node, etc.) as input to generate an object distribution time for each node.

At step 1110, the object distribution optimization system may provide the object distribution requests to the distribution system nodes, along with the determined object distribution times for distribution of the objects associated with the object request to the object distribution processor endpoint for distribution to the recipient. This may cause each of the distribution system nodes to prepare the various objects in the object request for transit to the object distribution processor endpoint on the designated object distribution time. In an embodiment, instead of providing the object distribution times for distribution of the objects to the object distribution processor, the object distribution optimization system can provide an object distribution request to a node on a time that allows the node to initiate transit of the object to the object distribution processor endpoint on the object distribution time determined by the object distribution optimization system. For instance, based on a set of performance metrics for a distribution system node, the object distribution optimization system may determine the amount of time required by the node to prepare and initiate transit of an object. Based on this determined amount of time and the identified object distribution time, the object distribution optimization system may identify a time at which the object distribution request may be provided to the distribution system node. Thus, the object distribution requests may also be provided to the distribution system nodes at different times.

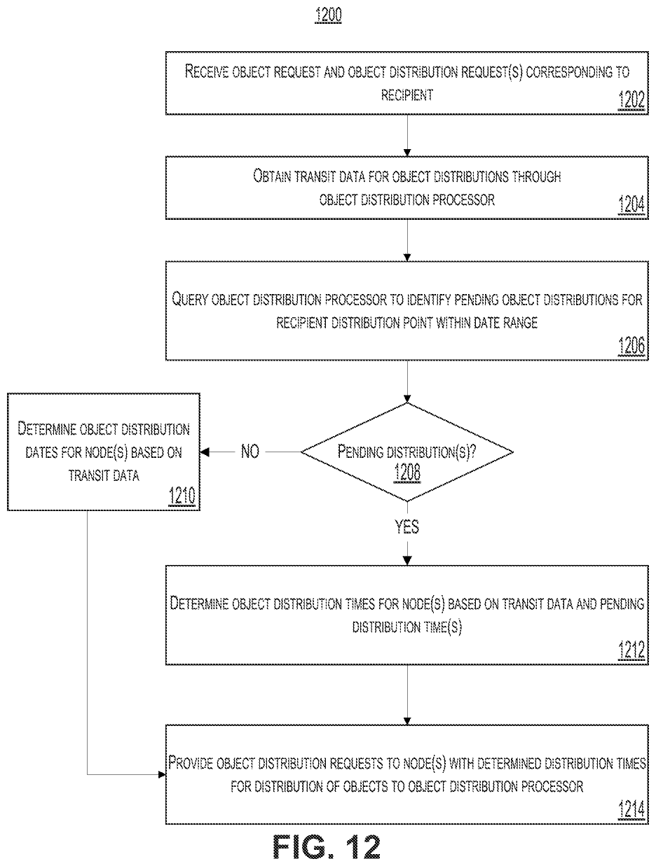

FIG. 12 shows an illustrative example of a process 1200 for determining object distribution times for distribution system nodes associated with an object distribution system based on object transit times associated with the distribution system nodes and pending object distributions from other object distribution systems in accordance with at least one embodiment. The process 1200 may be performed by the object distribution optimization system, which may utilize transit data associated with an object distribution processor to determine the transit times from distribution system nodes associated with an object distribution system to the object distribution processor for distribution of objects to a recipient. Further, the process 1200 may be performed in an environment wherein objects from multiple object distribution systems can be consolidated at the object distribution processor to allow for consolidated distribution of these objects to a recipient on a particular time as determined by the object distribution optimization system. Thus, as opposed to the process 1100 described above, whereby split objects from a particular object request associated with an object distribution system are consolidated, the process 1200 is performed in environments wherein objects from myriad object distribution systems utilizing the object distribution optimization system destined for a particular destination can be consolidated for distribution within a particular object distribution timeframe.

At step 1202, the object distribution optimization system receives, from an object distribution system, an object request and corresponding object distribution requests associated with a particular recipient. The object requests for a particular recipient may indicate the objects requested by the recipient, the resources allocated by the recipient for the objects, an object distribution time or range provided to the recipient by the object distribution system, and the like. The object distribution requests associated with a particular recipient may include the individual object distribution requests that are to be provided to the one or more distribution system nodes associated with the object distribution system for transiting of a portion of the object request to an object distribution processor for distribution to a destination designated by the recipient when placing their object request to the object distribution system. For instance, a portion of an object request may be fulfilled by one node while another portion of the object request may be fulfilled by a different node. These distribution system nodes may be implemented in different locations. For instance, distribution system nodes may each be assigned to maintain and transit certain objects or classes of objects on behalf of the object distribution system. Alternatively, a distribution system node may maintain certain objects or classes of objects that are subject to greater demand within a particular region associated with the node. Thus, a set of objects requested by a recipient may be maintained in different nodes and in different regions.

At step 1204, the object distribution optimization system obtains transit data for object distributions through the object distribution processor. For instance, the object distribution optimization system may transmit a request to the object distribution processor to obtain the transit data associated with an object distribution processor endpoint to which the objects associated with the object request may be transited for consolidation in anticipation of distribution to the recipient. In its request, the object distribution optimization system may provide the destination to which the objects are to be distributed, as well as any recipient preferences for distribution (e.g., preferred object distribution time(s), etc.), and other recipient information that may be used to identify any pending object distributions to the same destination from one or more other object distribution systems.

At step 1206, the object distribution optimization system queries the object distribution processor to identify any pending object distributions for the recipient at the designated destination within the preferred object distribution times, or ranges, specified by the recipient in their object request. As noted above, the object distribution optimization system may transmit, to the object distribution processor, the destination to which the objects specified in the object request are to be distributed, as well as the preferred object distribution times or ranges of times for distribution of the objects. Using this information, the object distribution processor may identify any other objects or object distributions that are to be performed for the same destination specified by the object distribution optimization system within the preferred object distribution times or ranges of times specified by the recipient in their object request through the object distribution system. For instance, if the object distribution processor determines that one or more object distributions are to be performed for the indicated destination on a preferred object distribution time or within a particular time range specified by the recipient, the object distribution processor may indicate, in its response to the object distribution optimization system, that other object distributions are scheduled to be performed at the destination and on a time corresponding to either the preferred time specified by the recipient or within the time range specified by the recipient. Alternatively, if the object distribution processor determines that no object distributions are to be performed at the specified destination on the preferred time or within the specified time range, the object distribution processor may indicate that no other object distributions are scheduled for the specified destination on the preferred time or within the specified time range.

Based on the response from the object distribution processor, the object distribution optimization system determines, at step 1208, whether there are any pending object distributions from other object distribution systems to the recipient's specified destination and scheduled for distribution on the preferred time or within the time range specified by the recipient in their object request. If the object distribution optimization system determines that there are no other pending object distributions from other object distribution systems scheduled to be performed at the recipient's specified destination on the preferred time or within the time range specified by the recipient, the object distribution optimization system, at step 1210, determines the object distribution times for the one or more distribution system nodes based on the obtained transit data from the object distribution processor. For instance, using the obtained transit data, the object distribution optimization system may determine the amount of time required to transit one or more objects from a particular node to the object distribution processor. Based on this amount of time, the object distribution optimization system may determine the time at which the node may be required to transit the one or more objects to the object distribution processor in order for distribution of the one or more objects to be performed at the destination specified by the recipient on the preferred time or within the data range specified by the recipient. The object distribution optimization system may perform this operation for each of the identified distribution system nodes that include the objects specified in the object request. Thus, while each of the identified nodes may be tasked with transiting their assigned objects on different times to the object distribution processor, based on the transit data, these objects may arrive at the object distribution processor on the same time in order to allow the object distribution processor to consolidate the objects from the various distribution system nodes and distribute the consolidated objects to the recipient at the indicated destination.

In an embodiment, if the object distribution optimization system determines that there are no other pending object distributions from other object distribution systems scheduled to be made to the recipient's specified destination, the object distribution optimization system automatically monitors, in real-time, the object distribution processor for a period of time to determine whether new pending object distributions have been obtained for the recipient's specified destination. If new pending object distributions are identified, the object distribution optimization system obtains the object distribution times for the pending object distributions and determines whether the object request associated with the recipient can be consolidated with these pending object distributions to allow for consolidated distribution of the recipient's objects on a particular time. If so, the object distribution optimization system may set this particular time for distribution and use the transit data to identify the object distribution time for each of the one or more nodes that are used to fulfill the object request to ensure that the objects in the object request arrive at the object distribution processor for consolidated distribution with the pending object distributions to the recipient.

If the object distribution optimization system determines that there are pending object distributions that are to be performed for other object distribution systems at the destination specified by the recipient, the object distribution optimization system, at step 1212, determines the object distribution times for the one or more distribution system nodes based on the obtained transit data and the pending object distribution times for other object distribution systems obtained from the object distribution processor. For instance, if the object distribution optimization system determines that one or more pending object distributions are to be performed at the destination specified by the recipient on a particular time, the object distribution optimization system may select this particular time as the time in which the objects from the one or more distribution system nodes are to arrive at the object distribution processor in order to allow the object distribution processor to consolidate these objects with the pending object distributions. In an embodiment, if the pending object distributions are scheduled within a particular time range that coincides with a time range provided by the recipient, the object distribution optimization system can coordinate with the object distribution processor to select a particular time for completing the pending object distributions and the distributing the one or more objects in the recipient request in a consolidated distribution to the recipient at the specified destination.

At step 1214, the object distribution optimization system provides the object distribution requests to the one or more distribution system nodes, along with the identified object distribution time for each of the one or more nodes, for distribution of the objects corresponding to the object request to the object distribution processor for consolidated distribution to the recipient. As noted above, the object distribution optimization system may utilize the transit data obtained from the object distribution processor to determine the transit time for objects from each node to the object distribution processor endpoint from which the consolidated distribution is to be made. Using these transit times and the object distribution time associated with the recipient, the object distribution optimization system may determine an object distribution time for each node in order to have the recipient's objects arrive at the object distribution processor in time for consolidation and distribution to the recipient on the specified distribution time. These object distribution times are provided to the one or more distribution system nodes, which may transit the objects to the object distribution processor on their designated object distribution times.

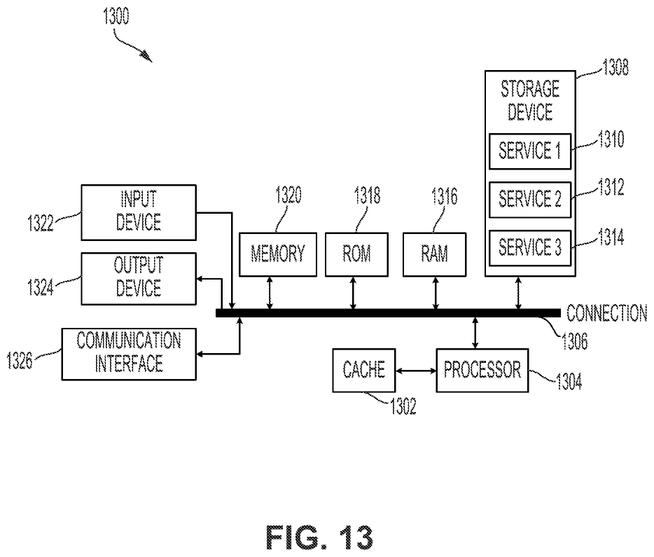

FIG. 13 illustrates a computing system architecture 1300 including various components in electrical communication with each other using a connection 1306, such as a bus, in accordance with some implementations. Example system architecture 1300 includes a processing unit (CPU or processor) 1304 and a system connection 1306 that couples various system components including the system memory 1320, such as ROM 1318 and RAM 1316, to the processor 1304. The system architecture 1300 can include a cache 1302 of high-speed memory connected directly with, in close proximity to, or integrated as part of the processor 1304. The system architecture 1300 can copy data from the memory 1320 and/or the storage device 1308 to the cache 1302 for quick access by the processor 1304. In this way, the cache can provide a performance boost that avoids processor 1304 delays while waiting for data. These and other modules can control or be configured to control the processor 1304 to perform various actions.

Other system memory 1320 may be available for use as well. The memory 1320 can include multiple different types of memory with different performance characteristics. The processor 1304 can include any general purpose processor and a hardware or software service, such as service 1 1310, service 2 1312, and service 3 1314 stored in storage device 1308, configured to control the processor 1304 as well as a special-purpose processor where software instructions are incorporated into the actual processor design. The processor 1304 may be a completely self-contained computing system, containing multiple cores or processors, a bus, memory controller, cache, etc. A multi-core processor may be symmetric or asymmetric.

To enable user interaction with the computing system architecture 1300, an input device 1322 can represent any number of input mechanisms, such as a microphone for speech, a touch-sensitive screen for gesture or graphical input, keyboard, mouse, motion input, speech and so forth. An output device 1324 can also be one or more of a number of output mechanisms known to those of skill in the art. In some instances, multimodal systems can enable a user to provide multiple types of input to communicate with the computing system architecture 1300. The communications interface 1326 can generally govern and manage the user input and system output. There is no restriction on operating on any particular hardware arrangement and therefore the basic features here may easily be substituted for improved hardware or firmware arrangements as they are developed.

Storage device 1308 is a non-volatile memory and can be a hard disk or other types of computer readable media which can store data that are accessible by a computer, such as magnetic cassettes, flash memory cards, solid state memory devices, digital versatile disks, cartridges, RAMs 1316, ROM 1318, and hybrids thereof.

The storage device 1308 can include services 1310, 1312, 1314 for controlling the processor 1304. Other hardware or software modules are contemplated. The storage device 1308 can be connected to the system connection 1306. In one aspect, a hardware module that performs a particular function can include the software component stored in a computer-readable medium in connection with the necessary hardware components, such as the processor 1304, connection 1306, output device 1324, and so forth, to carry out the function.

The disclosed system can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving an object request, wherein the object request corresponds to a set of objects associated with an object distribution system and a destination for distribution of the set of objects;
generating in real-time a dataset, wherein the dataset includes sample object requests and sample object distribution times corresponding to different nodes associated with a set of object distribution systems, and wherein the sample object distribution times facilitate consolidation of objects associated with the sample objects requests into singular object distributions;
dynamically training in real-time a machine learning algorithm to automatically generate a set of object distribution times corresponding to a set of nodes associated with the object distribution system;
obtaining transit data associated with an object distribution processor, wherein the transit data indicates transit times from the set of nodes to an endpoint corresponding to the object distribution processor and the destination;
processing the object request, the transit data, and data corresponding to the set of nodes through the machine learning algorithm to identify a set of times for transiting the set of objects from the set of nodes to the endpoint; and
generating a set of object distribution requests, wherein the set of object distribution requests include the object request and the set of times, and wherein when the object distribution requests are received, the set of nodes transit the set of objects to the endpoint according to the set of times to allow for consolidation of the set of objects at the endpoint for consolidated distribution.

2. The computer-implemented method of claim 1, further comprising:
identifying other times corresponding to a set of pending object distributions associated with the endpoint and the destination;
determining that the set of objects can be consolidated with other objects associated with the set of pending object distributions based on the set of times and the other times; and
updating the consolidated distribution to incorporate the set of pending object distributions.

3. The computer-implemented method of claim 1, further comprising:
identifying one or more pending object distributions associated with the endpoint, wherein the one or more pending object distributions are to be performed at other destinations;
identifying a set of times corresponding to the one or more pending object distributions; and
providing one or more object distribution options for distribution of the set of objects to the other destinations within the set of times.

4. The computer-implemented method of claim 1, wherein the object request is received through an instance of a SaaS-based system accessed through one or more application programming interface (API) calls.

5. The computer-implemented method of claim 1, wherein the set of nodes are located in different regions.

6. The computer-implemented method of claim 1, further comprising:
dynamically training in real-time another machine learning algorithm to generate a set of distribution options, wherein the other machine learning algorithm is dynamically trained using prior object requests; and
providing the set of distribution options, wherein when a distribution option from the set of distribution options is selected, the object request is generated.

7. The computer-implemented method of claim 1, wherein:
the object request indicates a target object distribution time for the distribution of the set of objects; and
the computer-implemented method further comprises determining based on the transit data and the target object distribution time whether the distribution is performable on the target object distribution time.

8. A system, comprising:
one or more processors; and
memory storing thereon instructions that, as a result of being executed by the one or more processors, cause the system to:
receive an object request, wherein the object request corresponds to a set of objects associated with an object distribution system and a destination for distribution of the set of objects;
generate in real-time a dataset, wherein the dataset includes sample object requests and sample object distribution times corresponding to different nodes associated with a set of object distribution systems, and wherein the sample object distribution times facilitate consolidation of objects associated with the sample objects requests into singular object distributions;
dynamically train in real-time a machine learning algorithm to automatically generate a set of object distribution times corresponding to a set of nodes associated with the object distribution system;
obtain transit data associated with an object distribution processor, wherein the transit data indicates transit times from the set of nodes to an endpoint corresponding to the object distribution processor and the destination;
process the object request, the transit data, and data corresponding to the set of nodes through the machine learning algorithm to identify a set of times for transiting the set of objects from the set of nodes to the endpoint; and
generate a set of object distribution requests, wherein the set of object distribution requests include the object request and the set of times, and wherein when the object distribution requests are received, the set of nodes transit the set of objects to the endpoint according to the set of times to allow for consolidation of the set of objects at the endpoint for consolidated distribution.

9. The system of claim 8, wherein the instructions further cause the system to:
identify other times corresponding to a set of pending object distributions associated with the endpoint and the destination;
determine that the set of objects can be consolidated with other objects associated with the set of pending object distributions based on the set of times and the other times; and
update the consolidated distribution to incorporate the set of pending object distributions.

10. The system of claim 8, wherein the instructions further cause the system to:
identify one or more pending object distributions associated with the endpoint, wherein the one or more pending object distributions are to be performed at other destinations;
identify a set of times corresponding to the one or more pending object distributions; and
provide one or more object distribution options for distribution of the set of objects to the other destinations within the set of times.

11. The system of claim 8, wherein the object request is received through an instance of a SaaS-based system accessed through one or more application programming interface (API) calls.

12. The system of claim 8, wherein the set of nodes are located in different regions.

13. The system of claim 8, wherein the instructions further cause the system to:
dynamically train in real-time another machine learning algorithm to generate a set of distribution options, wherein the other machine learning algorithm is dynamically trained using prior object requests; and
provide the set of distribution options, wherein when a distribution option from the set of distribution options is selected, the object request is generated.

14. The system of claim 8, wherein:
the object request indicates a target object distribution time for the distribution of the set of objects; and
the instructions further cause the system to determine based on the transit data and the target object distribution time whether the distribution is performable on the target object distribution time.

15. A non-transitory, computer-readable storage medium storing thereon executable instructions that, as a result of being executed by one or more processors of a computer system, cause the computer system to:
receive an object request, wherein the object request corresponds to a set of objects associated with an object distribution system and a destination for distribution of the set of objects;
generate in real-time a dataset, wherein the dataset includes sample object requests and sample object distribution times corresponding to different nodes associated with a set of object distribution systems, and wherein the sample object distribution times facilitate consolidation of objects associated with the sample objects requests into singular object distributions;
dynamically train in real-time a machine learning algorithm to automatically generate a set of object distribution times corresponding to a set of nodes associated with the object distribution system;
obtain transit data associated with an object distribution processor, wherein the transit data indicates transit times from the set of nodes to an endpoint corresponding to the object distribution processor and the destination;
process the object request, the transit data, and data corresponding to the set of nodes through the machine learning algorithm to identify a set of times for transiting the set of objects from the set of nodes to the endpoint; and
generate a set of object distribution requests, wherein the set of object distribution requests include the object request and the set of times, and wherein when the object distribution requests are received, the set of nodes transit the set of objects to the endpoint according to the set of times to allow for consolidation of the set of objects at the endpoint for consolidated distribution.

16. The non-transitory, computer-readable storage medium of claim 15, wherein the executable instructions further cause the computer system to:
identify other times corresponding to a set of pending object distributions associated with the endpoint and the destination;
determine that the set of objects can be consolidated with other objects associated with the set of pending object distributions based on the set of times and the other times; and
update the consolidated distribution to incorporate the set of pending object distributions.

17. The non-transitory, computer-readable storage medium of claim 15, wherein the executable instructions further cause the computer system to:
identify one or more pending object distributions associated with the endpoint, wherein the one or more pending object distributions are to be performed at other destinations;
identify a set of times corresponding to the one or more pending object distributions; and
provide one or more object distribution options for distribution of the set of objects to the other destinations within the set of times.

18. The non-transitory, computer-readable storage medium of claim 15, wherein the object request is received through an instance of a SaaS-based system accessed through one or more application programming interface (API) calls.

19. The non-transitory, computer-readable storage medium of claim 15, wherein the set of nodes are located in different regions.

20. The non-transitory, computer-readable storage medium of claim 15, wherein the executable instructions further cause the computer system to:
dynamically train in real-time another machine learning algorithm to generate a set of distribution options, wherein the other machine learning algorithm is dynamically trained using prior object requests; and
provide the set of distribution options, wherein when a distribution option from the set of distribution options is selected, the object request is generated.

21. The non-transitory, computer-readable storage medium of claim 15, wherein:
the object request indicates a target object distribution time for the distribution of the set of objects; and
the executable instructions further cause the computer system to determine based on the transit data and the target object distribution time whether the distribution is performable on the target object distribution time.
